(19) United States
(12) Patent Application Publication
(10) Pub. No.: US 2023/0319949 A1
(43) Pub. Date: Oct. 5, 2023

(54) METHOD AND APPARATUS FOR SIDELINK TRANSMISSION IN CASE OF DISCONTINUOUS RECEPTION

(71) Applicant: Telefonaktiebolaget LM Ericsson (publ), Stockholm (SE)

(72) Inventor: Min Wang, Luleå (SE)

(21) Appl. No.: 18/018,893

(22) PCT Filed: Jul. 15, 2021
(86) PCT No.: PCT/EP2021/069859

§ 371 Date: Jan. 31, 2023

(30) Foreign Application Priority Data
Jul. 31, 2020 (WO) PCT/EP2020/071699

(51) Int. Cl. H04W 76/28

(52) U.S. Cl. CPC H04W 76/28

(57) ABSTRACT

Various embodiments of the present disclosure provide a method for a first terminal device, one or multiple second terminal devices and a network node. The method for the first terminal device comprises determining a sidelink transmission configuration for at least one service type or QoS requirement. The sidelink DRX is configured for the first terminal device and one or multiple second terminal devices. The method for the first terminal device further comprises determining, based on the sidelink transmission configuration, at least one transmission resource and/or at least one transmission time occasion for transmission of data associated with the at least one service type or the QoS requirement. The method for the first terminal device further comprises transmitting the data associated with the service type or the QoS requirement to the one or multiple second terminal devices over the sidelink according to the determined at least one transmission resource and/or at least one transmission time occasion.

### FIELD OF THE INVENTION

The present disclosure generally relates to communication networks, and more specifically, to a sidelink transmission in case of Discontinuous Reception.

### BACKGROUND

This section introduces aspects that may facilitate a better understanding of the disclosure. Accordingly, the statements of this section are to be read in this light and are not to be understood as admissions about what is in the prior art or what is not in the prior art.

Next generation systems are expected to support a wide range of use cases with varying requirements ranging from fully mobile devices to stationary Internet of things (IoT) or fixed wireless broadband devices. The traffic pattern associated with many use cases is expected to consist of short or long bursts of data traffic with varying length of waiting period in between.

Similar to Long Term Evolution (LTE), New Radio (NR) uses Orthogonal Frequency Division Multiplexing (OFDM) in the downlink, i.e. from a network node, gNB, eNB, or base station, to a user equipment (UE). The basic NR physical resource over an antenna port can thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈(0,1,2,3,4). Δf=15 kHz is the basic (or reference) subcarrier spacing that is also used in LTE.

In the time domain, downlink and uplink transmissions in NR will be organized into equally-sized subframes of 1 ms each similar to LTE. A subframe is further divided into multiple slots of equal duration. The slot length for subcarrier spacing Δf=(15×2\hat{ }μ) kHz is ½\hat{ }μ ms. There is only one slot per subframe for Δf=15 kHz and a slot consists of 14 OFDM symbols.

Downlink transmissions are dynamically scheduled, i.e., in each slot the gNB transmits downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including Synchronization Signal Block (SSB), Channel State Information Reference Signal (CSI-RS), etc.

Uplink data transmissions, carried on Physical Uplink Shared Channel (PUSCH), can also be dynamically scheduled by the (next) generation node B (gNB) by transmitting a DCI., the DCI (which is transmitted in the DL region) always indicates a scheduling time offset so that the PUSCH is transmitted in a slot in the UL region.

Sidelink is a special kind of communication mechanism between device and device without going through Evolved Node B (eNB) or gNB.

Discontinuous Reception (DRX) is a method used in mobile communication to conserve the battery of the mobile device. The mobile device and the network negotiate phases in which data transfer occurs. During other times the device turns its receiver off and enters a low power state.

As described in Petar Popovski; Kasper Fløe Trillingsgaard; Osvaldo Simeone and Giuseppe Durisi “5G Wireless Network Slicing for eMBB, URLLC, and mMTC: A Communication-Theoretic View”, IEEE Access, 28 Sep. 2018, vol. 6, pp. 55765-55779, which is incorporated herein by reference in its entirety, 5G wireless systems supports three generic service types: enhanced mobile broadband (eMBB), massive machine-type communications (mMTC), and ultra-reliable and low latency communications (URLLC) (may also referred to as mission-critical communications). eMBB supports stable connections with very high peak data rates, as well as moderate rates for cell-edge users. mMTC supports a massive number of Internet of Things (IoT) devices, which are only sporadically active and send small data payloads. URLLC supports low-latency transmissions of small payloads with very high reliability from a limited set of terminals, which are active according to patterns typically specified by outside events, such as alarms.

eMBB traffic can be considered to be a direct extension of the 4G broadband service. It is characterized by large payloads and by a device activation pattern that remains stable over an extended time interval. This allows the network to schedule wireless resources to the eMBB devices such that no two eMBB devices access the same resource simultaneously. The objective of the eMBB service is to maximize the data rate, while guaranteeing a moderate reliability, with packet error rate (PER) on the order of 10⁻³. For eMBB, the QoS requirement for user plane latency should be 4 ms for UL, and 4 ms for DL.

In contrast, an mMTC device is active intermittently and uses a fixed, typically low, transmission rate in the uplink. A huge number of mMTC devices may be connected to a given base station (BS), but at a given time only an unknown (random) subset of them becomes active and attempt to send their data. The large number of potentially active mMTC devices makes it infeasible to allocate a priori resources to individual mMTC devices. Instead, it is necessary to provide resources that can be shared through random access. The size of the active subset of mMTC devices is a random variable, whose average value measures the mMTC traffic arrival rate. The objective in the design of mMTC is to maximize the arrival rate that can be supported in a given radio resource. The targeted PER of an individual mMTC transmission is typically low, e.g., on the order of 10⁻¹.

The manufacturing industry is evolving fast, and industry leaders are searching for ways to stay ahead in their factories with increased flexibility in the production automation and assembly processes while also reducing personnel safety risks.

URLLC service requires very low latency and strict latency bounds with required guarantee levels to avoid triggering safety stops in the system. This is of great significance for the industrial automation industry, as it opens the door for safe human-robot interaction, which was previously only possible over a wired network.

As described in 3GPP TR 38.913 V15.0.0, which is incorporated herein by reference in its entirety, URLLC service need to fulfill the below QoS requirements:
Control plane latency: 10 ms;
User plane latency: it is the time it takes to successfully deliver an application layer packet/message from the radio protocol layer 2/3 SDU ingress point to the radio protocol layer 2/3 SDU egress point via the radio interface in both uplink and downlink directions. The requirement is 0.5 ms for both UL and DL;
Mobility interruption time: The requirement is 0 ms. It is the shortest time duration supported by the system during which a user terminal cannot exchange user plane packets;
Reliability: Reliability is defined as the success probability R of transmitting X bits within a certain delay at a certain channel quality (e.g. coverage-edge). A general URLLC reliability requirement for one transmission of a packet is 1-10⁻⁵ for 32 bytes with a user plane latency of 1 ms.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes an improved solution of sidelink transmission in case of Discontinuous Reception.

According to a first aspect of the present disclosure, there is provided a method implemented at a terminal device. The method comprises determining a sidelink transmission configuration for at least one service type or Quality of Service (QoS) requirement. Sidelink Discontinuous Reception (DRX) is configured for the first terminal device and one or multiple second terminal devices. The method further comprises determining at least one transmission resource and/or at least one transmission time occasion for transmission of data associated with the at least one service type or the QoS requirement based on the sidelink transmission configuration. The method further comprises transmitting the data associated with the service type or the QoS requirement to the one or multiple second terminal devices over the sidelink.

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices.

In accordance with an exemplary embodiment, determining at least one transmission resource and/or at least one transmission time occasion further comprises: determining the at least one transmission resource and/or at least one transmission time occasion without consideration of a DRX state of the one or multiple second terminal devices, when the first sidelink transmission configuration is determined for the service type or QoS requirement; or determining the at least one transmission resource and/or at least one transmission time occasion with consideration of a DRX state of the one or multiple second terminal devices, when the second sidelink transmission configuration is determined for the service type or QoS requirement.

In accordance with an exemplary embodiment, the DRX state comprises active state or idle state.

In accordance with an exemplary embodiment, the method according to the first aspect of the present disclosure may further comprise transmitting an indication to the one or multiple second terminal devices or a network node, wherein the indication at least indicates the determined at least one transmission resource and/or at least one transmission time occasion.

In accordance with an exemplary embodiment, the indication indicates at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

In accordance with an exemplary embodiment, the method according to the first aspect of the present disclosure may further comprise receiving a reply message from the one or multiple second terminal devices or a network node. The reply message at least indicates whether the one or multiple second terminal devices will switch to active state from idle state to receive the data.

In accordance with an exemplary embodiment, the indication is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the data and/or indication is transmitted via at least one of dedicated sidelink transmission, groupcast sidelink transmission or broadcast sidelink transmission.

In accordance with an exemplary embodiment, the reply message is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, transmitting the indication to the one or multiple second terminal devices or the network node further comprises: transmitting the indication in a first transmission time occasion according to the DRX state of the one or multiple second terminal devices.

In accordance with an exemplary embodiment, transmitting the indication to the one or multiple second terminal devices or the network node further comprises: transmitting the indication prior to transmitting the data associated with the service type or the QoS requirement.

In accordance with an exemplary embodiment, the indication is transmitted to the one or multiple second terminal devices together with at least part of the data associated with the service type or the QoS requirement.

In accordance with an exemplary embodiment, transmitting the data associated with the service type or the QoS requirement to the one or multiple second terminal devices over the sidelink further comprises: transmitting the data associated with the service type or the QoS requirement after a time period of transmitting the indication.

In accordance with an exemplary embodiment, the time period is pre-configured.

In accordance with an exemplary embodiment, the first terminal device and the one or multiple second terminal devices have a same DRX configuration.

In accordance with an exemplary embodiment, the method according to the first aspect of the present disclosure may further comprise transmitting a DRX configuration for the first terminal device to the one or multiple second terminal devices or a network node; and/or receiving at least one DRX configuration for the one or multiple second terminal devices from the one or multiple second terminal devices or a network node.

In accordance with an exemplary embodiment, the DRX configuration is transmitted or received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, determining at least one transmission resource and/or at least one transmission time occasion may further comprise : determining the at least one transmission resource during the at least one transmission time occasion when the one or multiple second terminal devices are in active state according to the DRX configuration for the one or multiple second terminal devices.

In accordance with an exemplary embodiment, determining at least one transmission resource and/or at least one transmission time occasion may further comprise : determining the at least one transmission time occasion based on the DRX state of the second terminal device, when the data and/or indication is to be transmitted via dedicated sidelink transmission.

In accordance with an exemplary embodiment, determining at least one transmission resource and/or at least one transmission time occasion may further comprise : determining the at least one transmission time occasion when at least X % of the multiple second terminal devices are in active state, when the data and/or indication is to be transmitted via groupcast sidelink transmission.

In accordance with an exemplary embodiment, determining at least one transmission resource and/or at least one transmission time occasion may further comprise : determining the at least one transmission time occasion when at least Y % of the multiple second terminal devices within a communication range of the first terminal device are in active state, when the data and/or indication is to be transmitted via broadcast sidelink transmission.

In accordance with an exemplary embodiment, the X, Y, and/or the communication range is pre-configured or configured by a network node, or determined based on the service type or the QoS requirement.

In accordance with an exemplary embodiment, determining a sidelink transmission configuration for at least one service type or QoS requirement may further comprise : determining the first sidelink transmission configuration for a delay sensitive service type or a service associated with a critical latency requirement; and/or determining the second sidelink transmission configuration for a delay insensitive service type or a service associated with a non-critical latency requirement.

In accordance with an exemplary embodiment, the method according to the first aspect of the present disclosure may further comprise receiving a configuring message indicating the sidelink transmission configuration for the at least one service type or QoS requirement from a network node.

In accordance with an exemplary embodiment, the configuring message is received via at least one of: a Radio Resource Control (RRC) signaling; a Media Access Control (MAC) Control element (CE); a Downlink Control Information (DCI); or a System Information (SI).

In accordance with an exemplary embodiment, determining a sidelink transmission configuration for at least one service type or QoS requirement is based on the configuring message received from the network node, or based on at least one capability indicator for the first terminal device indicating whether the first terminal device supports the first sidelink transmission configuration or the second sidelink transmission configuration.

In accordance with an exemplary embodiment, the method according to the first aspect of the present disclosure may further comprise transmitting a determination of the first sidelink transmission configuration or the second sidelink transmission configuration to the one or multiple second terminal devices or a network node.

In accordance with an exemplary embodiment, the determination is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, determining a sidelink transmission configuration for at least one service type or QoS requirement is independent of the DRX state of the first terminal device.

According to a second aspect of the present disclosure, there is provided an apparatus implemented in a first terminal device. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus implemented in a first terminal device. The apparatus comprises a first determining module, a second determining module and a transmitting module. In accordance with some exemplary embodiments, the first determining module is operable to carry out at least the first determining step of the method according to the first aspect of the present disclosure. The second determining module is operable to carry out at least the second determining step of the method according to the first aspect of the present disclosure. The transmitting module is operable to carry out at least the transmitting step of the method according to the first aspect of the present disclosure.

According to a fifth aspect of the present disclosure, there is provided a method implemented at a second terminal device. The method comprises receiving data associated with at least one service type or Quality of Service (QoS) requirement from a first terminal device over the sidelink. At least one transmission resource and/or at least one transmission time occasion is determined for transmission of the data associated with the at least one service type or QoS requirement by the first terminal device based on a sidelink transmission configuration. Sidelink Discontinuous Reception (DRX) is configured for the first terminal device and second terminal device.

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices.

In accordance with an exemplary embodiment, the DRX state comprises active state or idle state.

In accordance with an exemplary embodiment, the method according to the first aspect of the present disclosure may further comprise receiving an indication from the first terminal device or a network node. The indication at least indicates the determined at least one transmission resource and/or at least one transmission time occasion.

In accordance with an exemplary embodiment, the indication indicates at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

In accordance with an exemplary embodiment, the method according to the first aspect of the present disclosure may further comprise transmitting a reply message to the first terminal device or a network node. The reply message at least indicates whether the one or multiple second terminal devices will switch to active state from idle state to receive the data.

In accordance with an exemplary embodiment, the indication is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the data and/or indication is received via at least one of dedicated sidelink transmission, groupcast sidelink transmission or broadcast sidelink transmission.

In accordance with an exemplary embodiment, the reply message is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the method according to the fifth aspect of the present disclosure may further comprise switching to active state from idle state at the indicated at least one transmission resource and/or at least one transmission time occasion, or switching to active state from idle state according to the DRX configuration for the second terminal device.

In accordance with an exemplary embodiment, the indication is transmitted from the first terminal device or the network node in a first transmission time occasion according to the DRX state of the second terminal device.

In accordance with an exemplary embodiment, receiving the indication from the first terminal device or a network node may further comprise receiving the indication prior to receiving the data associated with the service type or the QoS requirement.

In accordance with an exemplary embodiment, the indication is received from the first terminal device or a network node together with at least part of the data associated with the service type or the QoS requirement.

In accordance with an exemplary embodiment, receiving data associated with at least one service type or QoS requirement from a first terminal device over the sidelink may further comprise receiving data associated with the service type or the QoS requirement after a time period of receiving the indication.

In accordance with an exemplary embodiment, the time period is pre-configured.

In accordance with an exemplary embodiment, the first terminal device and the one or multiple second terminal devices have a same DRX configuration.

In accordance with an exemplary embodiment, the method according to the fifth aspect of the present disclosure may further comprise receiving a DRX configuration for the first terminal device from the first terminal device or a network node; and/or transmitting a DRX configuration for second terminal device to the first terminal device or a network node.

In accordance with an exemplary embodiment, the DRX configuration is transmitted or received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, at least one transmission resource during the at least one transmission time occasion when the second terminal device is in active state according to a DRX configuration for the second terminal device is determined.

In accordance with an exemplary embodiment, at least one transmission time occasion based on the DRX state of the second terminal device is determined, when the data and/or indication is to be received via dedicated sidelink transmission.

In accordance with an exemplary embodiment, the first sidelink transmission configuration is determined for a delay sensitive service type or a service associated with a critical latency requirement; and/or the second sidelink transmission configuration is determined for a delay insensitive service type or a service associated with a non-critical latency requirement.

In accordance with an exemplary embodiment, the method according to the fifth aspect of the present disclosure may further comprise receiving a configuring message indicating the sidelink transmission configuration for the at least one service type or QoS requirement from a network node.

In accordance with an exemplary embodiment, the configuring message is received via at least one of: a Radio Resource Control (RRC) signaling; a Media Access Control (MAC) Control element (CE); a Downlink Control Information (DCI); or a System Information (SI).

In accordance with an exemplary embodiment, the method according to the fifth aspect of the present disclosure may further comprise receiving a determination of the first sidelink transmission configuration or the second sidelink transmission configuration from the first terminal device or a network node.

In accordance with an exemplary embodiment, the determination is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the determination of the sidelink transmission configuration for at least one service type or QoS requirement is independent of the DRX state of the first terminal device.

According to a sixth aspect of the present disclosure, there is provided an apparatus implemented in a second terminal device. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus implemented in a second terminal device. The apparatus comprises a receiving module. In accordance with some exemplary embodiments, the receiving module is operable to carry out at least the first receiving step of the method according to the fifth aspect of the present disclosure.

According to a nineth aspect of the present disclosure, there is provided a method implemented at a network node. The method comprises transmitting a configuring message indicating a sidelink transmission configuration for at least one service type or Quality of Service (QoS) requirement, to a first terminal device and/or one or multiple second terminal devices, or transmitting the sidelink transmission configuration for at least one service type or QoS requirement to the one or multiple second terminal devices. Sidelink Discontinuous Reception (DRX) is configured for the first terminal device and one or multiple second terminal devices.

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices.

In accordance with an exemplary embodiment, the method according to the nineth aspect of the present disclosure may further comprise receiving an indication from the first terminal device and/or transmitting the indication to the one or multiple second terminal devices. The indication at least indicates at least one transmission resource and/or at least one transmission time occasion.

In accordance with an exemplary embodiment, the indication indicates at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

In accordance with an exemplary embodiment, the method according to the nineth aspect of the present disclosure may further comprise receiving a reply message from the one or multiple second terminal devices, and/or transmitting the reply message to the first terminal devices. The reply message at least indicates whether the one or multiple second terminal devices will switch to active state from idle state to receive data associated with the service type or the QoS requirement from the first terminal device over the sidelink.

In accordance with an exemplary embodiment, the indication is received and/or transmitted via a cellular connection, and/or the reply message is transmitted and/or received via a cellular connection.

In accordance with an exemplary embodiment, the method according to the nineth aspect of the present disclosure may further comprise at least one of: receiving a DRX configuration for the first terminal device from the first terminal device; transmitting a DRX configuration for the first terminal device to one or multiple second terminal devices; receiving at least one DRX configuration for the one or multiple second terminal devices from the one or multiple second terminal devices; or transmitting the at least one DRX configuration for the one or multiple second terminal devices to the first terminal device.

In accordance with an exemplary embodiment, the configuring message and/or the sidelink transmission configuration is transmitted via at least one of: a Radio Resource Control (RRC) signaling; a Media Access Control (MAC) Control element (CE); a Downlink Control Information (DCI); or a System Information (SI).

In accordance with an exemplary embodiment, the method according to the nineth aspect of the present disclosure may further comprise determining the configuring message indicating sidelink transmission configuration for at least one service type or QoS requirement; or receiving the sidelink transmission configuration for at least one service type or QoS requirement from the first terminal device.

In accordance with an exemplary embodiment, the method according to the nineth aspect of the present disclosure may further comprise receiving a determination of the first sidelink transmission configuration or the second sidelink transmission configuration from the first terminal device; and/or transmitting the determination of the first sidelink transmission configuration or the second sidelink transmission configuration to the one or multiple second terminal devices.

According to a tenth aspect of the present disclosure, there is provided an apparatus implemented in a network node. The apparatus comprises one or more processors and one or more memories comprising computer program codes. The one or more memories and the computer program codes are configured to, with the one or more processors, cause the apparatus at least to perform any step of the method according to the nineth aspect of the present disclosure.

According to a eleventh aspect of the present disclosure, there is provided a computer-readable medium having computer program codes embodied thereon which, when executed on a computer, cause the computer to perform any step of the method according to the nineth aspect of the present disclosure.

According to a twelfth aspect of the present disclosure, there is provided an apparatus implemented in a network node. The apparatus comprises a first transmitting module or a second transmitting module. In accordance with some exemplary embodiments, the first transmitting module is operable to carry out at least the first transmitting step of the method according to the nineth aspect of the present disclosure. The second transmitting module is operable to carry out at least the second transmitting step of the method according to the nineth aspect of the present disclosure.

According to a thirteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the nineth aspect of the present disclosure.

According to a fourteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the nineth aspect of the present disclosure.

According to a fifteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first or the fifth aspect of the present disclosure.

According to a sixteenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first or fifth aspect of the present disclosure.

According to a seventeenth aspect of the present disclosure, there is provided a method implemented in a communication system which may include a host computer, a base station and a UE. The method may comprise, at the host computer, receiving user data transmitted to the base station from the UE which may perform any step of the method according to the first or fifth aspect of the present disclosure.

According to an eighteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first or fifth aspect of the present disclosure.

According to a nineteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the nineth aspect of the present disclosure.

According to a twentieth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the nineth aspect of the present disclosure.

With above aspects of the present disclosure, when DRX is configured for the terminal devices, a good balance between sidelink energy saving and QoS satisfaction of the transmissions can be achieved.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is an example of NR physical resource grid;

FIG. 2 is a flowchart illustrating a method according to some embodiments of the present disclosure;

FIG. 3 is a flowchart illustrating another method according to some embodiments of the present disclosure;

FIG. 4 is a flowchart illustrating yet another method according to some embodiments of the present disclosure;

FIG. 5 is a flowchart illustrating yet another method according to some embodiments of the present disclosure;

FIG. 6 is a block diagram illustrating an apparatus according to some embodiments of the present disclosure;

FIG. 7A-C are block diagrams illustrating another apparatuses according to some embodiments of the present disclosure respectively;

FIG. 8 is a block diagram illustrating a telecommunication network connected via an intermediate network to a host computer in accordance with some embodiments of the present disclosure;

FIG. 9 is a block diagram illustrating a host computer communicating via a base station with a UE over a partially wireless connection in accordance with some embodiments of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure; and

FIG. 13 is a flowchart illustrating a method implemented in a communication system, in accordance with an embodiment of the present disclosure.

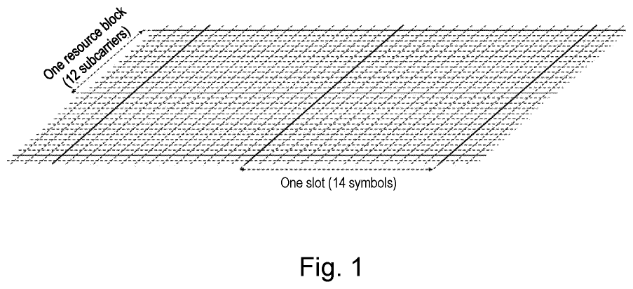

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G, 6G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like. In the following description, terms “terminal device” and “UE” will be used interchangeably.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Sidelink transmissions over NR are specified for Rel. 16. These are enhancements of the Proximity Services (ProSe), a Proximity-Based Services, specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management is supported in NR sidelink transmissions.

To enable the above enhancements, new physical channels and reference signals are introduced in NR (available in LTE before.):
Physical Sidelink Shared Channel (PSSCH), sidelink (SL) version of Physical Downlink Shared Channel (PDSCH): The PSSCH is transmitted by a sidelink transmitter UE, which conveys sidelink transmission data, system information blocks (SIBs) for radio resource control (RRC) configuration, and a part of the sidelink control information (SCI).
Physical Sidelink Feedback Channel (PSFCH), SL version of Physical Uplink Control Channel (PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
Physical Sidelink Common Control Channel (PSCCH), SL version of Physical Downlink Control Channel (PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
Demodulation Reference Signal (DMRS), phase tracking reference signal (PT-RS), channel state information reference signal (CSIRS): These physical reference signals supported by NR downlink/uplink transmissions are also adopted by sidelink transmissions. Similarly, the PT-RS is only applicable for transmissions in NR FR2 frequency band region.

Another new feature is the two-stage sidelink control information (SCI). This a version of the DCI for SL. Unlike the DCI, only part (first stage) of the SCI is sent on the PSCCH. This part is used for channel sensing purposes, including the reserved time-frequency resources for transmissions, demodulation reference signal (DMRS) pattern and antenna port, etc., and can be read by all UEs while the remaining (second stage) scheduling and control information such as a 8-bits source identity (ID) and a 16-bits destination identity (ID), New Data Indicator (NDI), Redundancy Version (RV) and Hybrid Automatic Repeat Request (HARQ) process ID is sent on the PSSCH to be decoded by the receiver UE.

Similar as for Proximity Services (PRoSE) in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a gNB, which are Scheduling Requests (SR) on Uplink (UL), grant, Buffer Status Report (BSR) on UL, grant for data on SL sent to UE. During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
The PSSCH associated with the PSCCH for initial transmission and blind retransmissions.
The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring Reference Signal Received Power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm are rather complex.

There are Device-to-device (D2D) discovery procedures for detection of services and applications offered by other UEs in close proximity. The discovery procedure has two modes, mode A based on open announcements (broadcasts) and mode B, which is request/response. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

As described in 3GPP 38.321, V16.0.0, which is incorporated herein by reference in its entirety, the MAC entity may be configured by Radio Resource Control (RRC) with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, and TPC-SRS-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in 3GPP TS 38.213, v16.2.0, which is incorporated herein by reference in its entirety.

RRC controls DRX operation by configuring the following parameters:
drx-onDurationTimer the duration at the beginning of a DRX Cycle;
drx-SlotOffset: the delay before starting the drx-onDurationTimer;
drx-InactivityTimer the duration after the PDCCH occasion in which a PDCCH indicates a new UL or DL transmission for the MAC entity;
drx-RetransmissionTimerDL (per downlink (DL) HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer in case DCP is monitored but not detected;
ps-Periodic_CSI_Transmit (optional): the configuration to report periodic CSI during the time duration indicated by drx-onDurationTimer in case DCP is configured but associated drx-onDurationTimer is not started;
ps-TransmitPeriodicL1-RSRP (optional): the configuration to transmit periodic L1-RSRP report(s) during the time duration indicated by drx-onDurationTimer in case DCP is configured but associated drx-onDurationTimer is not started.

When a DRX cycle is configured, the Active Time includes the time while:
drx-onDurationTimer or drx-InactivityTimer or drx-RetransmissionTimerDL or drx-RetransmissionTimerUL or ra-ContentionResolutionTimer (as described in clause 5.1.5 in 3GPP 38.321, V16.0.0) is running; or
a Scheduling Request is sent on PUCCH and is pending (as described in clause 5.4.4 in 3GPP 38.321, V16.0.0); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clause 5.1.4 in 3GPP 38.321, V16.0.0).
   During these above active time periods, the UE is in active state (also referred to as DRX active state), while during other time periods within a DRX cycle, the UE is in inactive state (also referred to as DRX inactive state).

When DRX is configured, the MAC entity shall:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
   2> stop the drx-RetransmissionTimerDL for the corresponding HARQ process.
1> if a MAC PDU is transmitted in a configured uplink grant:
   2> start the drx-HARQ-RTT-TimerUL for the corresponding HARQ process in the first symbol after the end of the first repetition of the corresponding PUSCH transmission;
   2> stop the drx-RetransmissionTimerUL for the corresponding HARQ process.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a drx-HARQ-RTT-TimerUL expires:
   2> start the drx-RetransmissionTimerUL for the corresponding HARQ process in the first symbol after the expiry of drx-HARQ-RTT-TimerUL.
1> if a DRX Command MAC CE or a Long DRX Command MAC CE is received:
   2> stop drx-onDurationTimer;
   2> stop drx-InactivityTimer.
1> if drx-InactivityTimer expires or a DRX Command MAC CE is received:
   2> if the Short DRX cycle is configured:
      3> start or restart drx-ShortCycleTimer in the first symbol after the expiry of drx-InactivityTimer or in the first symbol after the end of DRX Command MAC CE reception;
      3> use the Short DRX Cycle.
   2> else:
      3> use the Long DRX cycle.
1> if drx-ShortCycleTimer expires:
   2> use the Long DRX cycle.
1> if a Long DRX Command MAC CE is received:
   2> stop drx-ShortCycleTimer;
   2> use the Long DRX cycle.
1> if the Short DRX Cycle is used, and [(SFN×10)+subframe number] modulo (drx-ShortCycle)=(drx-StartOffset) modulo (drx-ShortCycle):
   2> start drx-onDurationTimer after drx-SlotOffset from the beginning of the subframe.
1> if the Long DRX Cycle is used, and [(SFN×10)+subframe number] modulo (drx-LongCycle)=drx-StartOffset:
   2> if DCP is configured for the active DL BWP:
      3> if DCP indication associated with the current DRX Cycle received from lower layer indicated to start drx-onDurationTimer, as specified in 3GPP TS 38.213, v16.2.0; or
      3> if all DCP occasion(s) in time domain, as specified in 3GPP TS 38.213, v16.2.0, associated with the current DRX Cycle occurred in Active Time considering grants/assignments/DRX Command MAC CE/Long DRX Command MAC CE received and Scheduling Request sent until 4 ms prior to start of the last DCP occasion, or within BWP switching interruption length, or during a measurement gap; or
      3> if ps-Wakeup is configured with value true and DCP indication associated with the current DRX Cycle has not been received from lower layers:
         4> start drx-onDurationTimer after drx-SlotOffset from the beginning of the subframe.
   2> else:
      3> start drx-onDurationTimer after drx-SlotOffset from the beginning of the subframe.
         NOTE 1: In case of unaligned SFN across carriers in a cell group, the SFN of the SpCell is used to calculate the DRX duration.
1> if the MAC entity is in Active Time:
   2> monitor the PDCCH as specified in 3GPP TS 38.213, v16.2.0;
   2> if the PDCCH indicates a DL transmission:
      3> start the drx-HARQ-RTT-TimerDL for the corresponding HARQ process in the first symbol after the end of the corresponding transmission carrying the DL HARQ feedback, regardless of LBT failure indication from lower layers;
         NOTE 2: When HARQ feedback is postponed by PDSCH-to-HARQ_feedback timing indicating a non-numerical k1 value, as specified in 3GPP TS 38.213, v16.2.0, the corresponding transmission opportunity to send the DL HARQ feedback is indicated in a later PDCCH requesting the HARQ-ACK feedback.
      3> stop the drx-RetransmissionTimerDL for the corresponding HARQ process.
      3> if the PDSCH-to-HARQ feedback timing indicate a non-numerical k1 value as specified in 3GPP TS 38.213, v16.2.0:
         4> start the drx-RetransmissionTimerDL in the first symbol after the PDSCH transmission for the corresponding HARQ process.
   2> if the PDCCH indicates a UL transmission:
      3> start the drx-HARQ-RTT-TimerUL for the corresponding HARQ process in the first symbol after the end of the first repetition of the corresponding PUSCH transmission, regardless of LBT failure indication from lower layers;
      3> stop the drx-RetransmissionTimerUL for the corresponding HARQ process.
   2> if the PDCCH indicates a new transmission (DL or UL):
      3> start or restart drx-InactivityTimer in the first symbol after the end of the PDCCH reception.
1> if DCP is configured for the active DL BWP; and
1> if the current symbol n occurs within drx-onDuration Timer duration; and
1> if drx-onDurationTimer associated with the current DRX cycle is not started as specified in this clause; and
1> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
   2> not transmit periodic SRS and semi-persistent SRS defined in 3GPP TS 38.214, v16.2.0;
   2> not report semi-persistent CSI configured on PUSCH;
   2> if ps-Periodic_CSI_Transmit is not configured with value true:
      3> if ps-TransmitPeriodicL1-RSRP is not configured with value true:
         4> not report periodic CSI on PUCCH.
      3> else:
         4> not report periodic CSI on PUCCH, except L1-RSRP report(s).
1> else:
   2> in current symbol n, if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
      3> not transmit periodic SRS and semi-persistent SRS defined in 3GPP TS 38.214, v16.2.0;
      3> not report CSI on PUCCH and semi-persistent CSI configured on PUSCH.
   2> if CSI masking (csi-Mask) is setup by upper layers:
      3> in current symbol n, if drx-onDurationTimer would not be running considering grants/assignments/DRX Command MAC CE/Long DRX Command MAC CE received until 4 ms prior to symbol n when evaluating all DRX Active Time conditions as specified in this clause:
         4> not report CSI on PUCCH.
            NOTE 3:If a UE multiplexes a CSI configured on PUCCH with other overlapping UCI(s) according to the procedure specified in 3GPP TS 38.213, v16.2.0 clause 9.2.5 and this CSI multiplexed with other UCI(s) would be reported on a PUCCH resource outside DRX Active Time, it is up to UE implementation whether to report this CSI multiplexed with other UCI(s).

Regardless of whether the MAC entity is monitoring PDCCH or not, the MAC entity transmits HARQ feedback, aperiodic CSI on PUSCH, and aperiodic SRS defined in 3GPP TS 38.214, v16.2.0 when such is expected, and 3GPP TS 38.214, v16.2.0 is incorporated herein by reference in its entirety.

The MAC entity needs not to monitor the PDCCH if it is not a complete PDCCH occasion (e.g. the Active Time starts or ends in the middle of a PDCCH occasion).

The RRC IE DRX-Config is used to configure DRX related parameters for a DRX configuration.

### DRX-Config Information Element

-- ASN1START
-- TAG-DRX-CONFIG-START

| | |
|---|---|
| DRX-Config ::= | SEQUENCE { |
| drx-onDurationTimer | CHOICE { |
| subMilliSeconds | INTEGER (1..31), |
| milliSeconds | ENUMERATED { |

```
      ms1, ms2, ms3, ms4, ms5, ms6, ms8, ms10, ms20, ms30, ms40, ms50, ms60,
      ms80, ms100, ms200, ms300, ms400, ms500, ms600, ms800, ms1000, ms1200,
      ms1600, spare8, spare7, spare6, spare5, spare4, spare3, spare2, spare1}
              }
```

| | |
|---|---|
| drx-InactivityTimer | ENMUERATED { |

```
    ms0, ms1, ms2, ms3, ms4, ms5, ms6, ms8, ms10, ms20, ms30, ms40, ms50, ms60,
ms80,
    ms100, ms200, ms300, ms500, ms750, ms1280, ms1920, ms2560, spare9, spare8,
    spare7, spare6, spare5, spare4, spare3, spare2, spare1},
```

| | |
|---|---|
| drx-HARQ-RTT-TimerDL | INTEGER (0..56), |
| drx-HARQ-RTT-TimerUL | INTEGER (0..56), |
| drx-RetransmissionTimerDL | ENUMERATED { |

```
        sl0, sl1, sl2, sl4, sl6, sl8, sl16, sl24, sl33, sl40, sl64, sl80, sl96, sl112, sl128,
        sl160, sl320, spare15, spare14, spare13, spare12, spare11, spare10, spare9,
        spare8, spare7, spare6, spare5, spare4, spare3, spare2, spare1},
```

| | |
|---|---|
| drx-RetransmissionTimerUL | ENUMERATED { |

```
        sl0, sl1, sl2, sl4, sl6, sl8, sl16, sl24, sl33, sl40, sl64, sl80, sl96, sl112, sl128,
        sl160, sl320, spare15, spare14, spare13, spare12, spare11, spare10, spare9,
        spare8, spare7, spare6, spare5, spare4, spare3, spare2, spare1 },
```

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |

```
        ms2, ms3, ms4, ms5, ms6, ms7, ms8, ms10, ms14, ms16, ms20, ms30, ms32,
        ms35, ms40, ms64, ms80, ms128, ms160, ms256, ms320, ms512, ms640,
spare9,
        spare8, spare7, spare6, spare5, spare4, spare3, spare2, spare1 },
```

| | |
|---|---|
| drx-ShortCycleTimer | INTEGER (1..16) |

}
OPTIONAL, -- Need R

| | |
|---|---|
| drx-SlotOffset | INTEGER (0..31) |

}
-- TAG-DRX-CONFIG-STOP
-- ASN1STOP

DRX-Config field descriptions

drx-HARQ-RTT-TimerDL
Value in number of symbols of the BWP where the transport block was received.
drx-HARQ-RTT-TimerUL
Value in number of symbols of the BWP where the transport block was transmitted.
drx-InactivityTimer
Value in multiple integers of 1 ms. ms0 corresponds to 0, ms1 corresponds to 1 ms, ms2
corresponds to 2 ms, and so on.
drx-LongCycleStartOffset
drx-LongCycle in ms and drx-StartOffset in multiples of 1 ms. If drx-ShortCycle is
configured, the value of drx-LongCycle shall be a multiple of the drx-ShortCycle value.
drx-onDurationTimer
Value in multiples of 1/32 ms (subMilliSeconds) or in ms (milliSecond). For the latter, value
ms1 corresponds to 1 ms, value ms2 corresponds to 2 ms, and so on.
drx-Retransmission TimerDL
Value in number of slot lengths of the BWP where the transport block was received. value
s/0 corresponds to 0 slots, s/1 corresponds to 1 slot, s/2 corresponds to 2 slots, and so
on.
drx-Retransmission TimerUL
Value in number of slot lengths of the BWP where the transport block was transmitted. s/0
corresponds to 0 slots, s/1 corresponds to 1 slot, s/2 corresponds to 2 slots, and so on.
drx-ShortCycleTimer
Value in multiples of drx-ShortCycle. A value of 1 corresponds to drx-ShortCycle, a value
of 2 corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2
corresponds to 2/32 ms, and so on.

UE energy saving is one important performance indicator. There is no energy saving feature defined for SideLink until 3GPP Rel-16. In 3GPP Rel-17 Work Item (WI) on NR sidelink enhancement and RP-193231, New WID on NR sidelink enhancement, which is incorporated herein by reference in its entirety, the below objective on UE Sidelink energy saving has been agreed and will be studied in 3GPP Rel-17 time frame:

Sidelink DRX for broadcast, groupcast, and unicast [RAN2];
Define on- and off-durations in sidelink and specify the corresponding UE procedure;
Specify mechanism aiming to align sidelink DRX wake-up time among the UEs communicating with each other;
Specify mechanism aiming to align sidelink DRX wake-up time with Uu DRX wake-up time in an in-coverage UE.

For NR cellular, a gNB may be always active, while a UE with DRX switches between active state and idle state. From the DRX configuration, the gNB is aware of the DRX state of the UE. The gNB only schedules the UE when the UE is in active state.

While for a sidelink, both the transmitter UE and the receiver UE can be configured with DRX, in this case, the transmitter UE may be not aware of the DRX state of the receiver UE, vice versa, the receiver UE may be not aware of the DRX state of the transmitter UE either. In an example, in the Mode 2 resource allocation mechanism, a UE can select resources autonomously for a Sidelink transmission targeting another UE. While the transmission takes place, the receiver UE may be still in idle state. This would lead to the transmission being lost.

Therefore, it is necessary to study how a Sidelink transmission should interact with DRX functionality so that to avoid the transmission being lost due to DRX state misalignment between the transmitter and the receiver.

A controlling mechanism for a sidelink based transmission in case that sidelink DRX is applied, is proposed for a transmitter UE. In the controlling mechanism, the transmitter UE controls the sidelink transmission considering the service type and/or QoS (e.g. latency) requirements associated with the transmission. If the transmission is associated with critical latency requirements, the transmitter UE determines the transmission occasions for its subsequent transmissions and informs the relevant information to the receivers UEs. If the transmission is not associated with critical latency requirements, the transmitter UE determines the transmission occasions for its subsequent transmissions considering the DRX states of receiver UEs. In other words, the transmitter UE performs transmissions to receiver UEs only when they are in active state according to their DRX configurations.

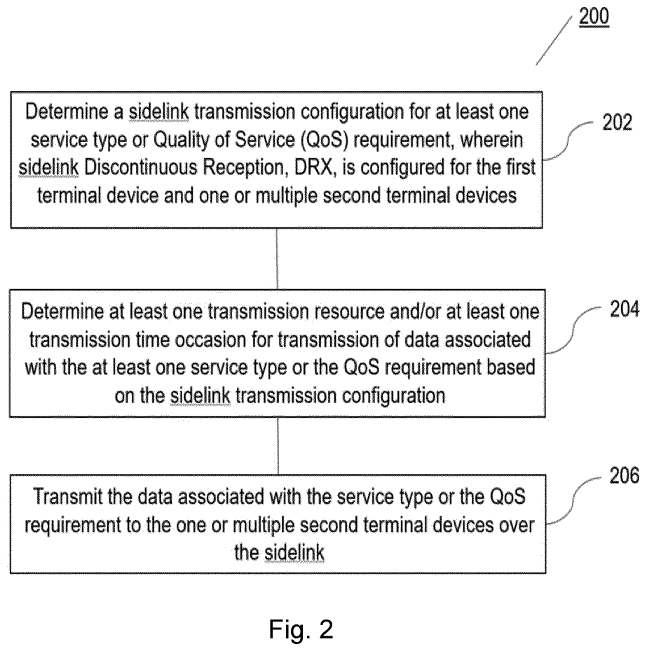

FIG. 2 is a flowchart illustrating a method 200 according to some embodiments of the present disclosure. The method 200 illustrated in FIG. 2 may be performed by an apparatus implemented in a first terminal device or communicatively coupled to a first terminal device. The first terminal device may be a transmitter UE to transmit data to one or more receiver UEs.

According to the exemplary method 200 illustrated in FIG. 2, the first terminal device such as a UE can determine a sidelink transmission configuration for at least one service type or Quality of Service (QoS) requirement, as shown in block 202. The sidelink transmission configuration relates to how the first terminal device is to determine at least one transmission resource and/or at least one transmission time occasion for transmission of data. Sidelink Discontinuous Reception (DRX) is configured for the first terminal device and one or multiple second terminal devices. As described in TS 23.501 V16.5.0 clause 5.7.1.1, the 5G QoS model is based on QoS Flows. The 5G QoS model supports both QoS Flows that require guaranteed flow bit rate (GBR QoS Flows) and QoS Flows that do not require guaranteed flow bit rate (Non-GBR QoS Flows). A service is typically modelled as a QoS flow. The QoS characteristics for the standardized 5G QoS identifiers of different services are specified in Table 5.7.4-1 in TS 23.501 V16.5.0, which is incorporated herein by reference in its entirety. The Quality of Service (QoS) requirement may comprise a latency, packet error rate (PER), mobility interruption time or reliability requirement greater than, equal to or lower than a respective threshold.

Table 5.7.4-1 in TS 23.501 V16.5.0: Standardized 5QI to QoS characteristics mapping

| | | | | | Default | | |
|---|---|---|---|---|---|---|---|
| | | | Packet | | Maximum | | |
| | | Default | Delay | Packet | Data Burst | Default | |
| 5QI | Resource | Priority | Budget | Error | Volume | Averaging | |
| Value | Type | Level | (NOTE 3) | Rate | (NOTE 2) | Window | Example Services |
| 1 | GBR | 20 | 100 ms | 10⁻² | N/A | 2000 ms | Conversational Voice |
| | (NOTE 1) | | (NOTE 11, | | | | |
| | | | NOTE 13) | | | | |
| 2 | | 40 | 150 ms | 10⁻³ | N/A | 2000 ms | Conversational Video |
| | | | (NOTE 11, | | | | (Live Streaming) |
| | | | NOTE 13) | | | | |
| 3 | | 30 | 50 ms | 10⁻³ | N/A | 2000 ms | Real Time Gaming, |
| | | | (NOTE 11, | | | | V2X messages (see |
| | | | NOTE 13) | | | | TS 23.287 [121]). |
| | | | | | | | Electricity distribution - |
| | | | | | | | medium voltage, |
| | | | | | | | Process automation |
| | | | | | | | monitoring |
| 4 | | 50 | 300 ms | 10⁻⁶ | N/A | 2000 ms | Non-Conversational |
| | | | (NOTE 11, | | | | Video (Buffered |
| | | | NOTE 13) | | | | Streaming) |
| 65 | | 7 | 75 ms | 10⁻² | N/A | 2000 ms | Mission Critical user |
| (NOTE 9, | | | (NOTE 7, | | | | plane Push To Talk |
| NOTE 12) | | | NOTE 8) | | | | voice (e.g., MCPTT) |
| 66 | | 20 | 100 ms | 10⁻² | N/A | 2000 ms | Non-Mission-Critical |
| (NOTE 12) | | | (NOTE 10, | | | | user plane Push To |
| | | | NOTE 13) | | | | Talk voice |
| 67 | | 15 | 100 ms | 10⁻³ | N/A | 2000 ms | Mission Critical Video |
| (NOTE 12) | | | (NOTE 10, | | | | user plane |
| | | | NOTE 13) | | | | |
| 75 | | | | | | | |
| (NOTE 14) | | | | | | | |
| 71 | | 56 | 150 ms | 10⁻⁶ | N/A | 2000 ms | “Live” Uplink Streaming |
| | | | (NOTE 11, | | | | (e.g. TS 26.238 [76]) |
| | | | NOTE 13, | | | | |
| | | | NOTE 15) | | | | |
| 72 | | 56 | 300 ms | 10⁻⁴ | N/A | 2000 ms | “Live” Uplink Streaming |
| | | | (NOTE 11, | | | | (e.g. TS 26.238 [76]) |
| | | | NOTE 13, | | | | |
| | | | NOTE 15) | | | | |
| 73 | | 56 | 300 ms | 10⁻⁸ | N/A | 2000 ms | “Live” Uplink Streaming |
| | | | (NOTE 11, | | | | (e.g. TS 26.238 [76]) |
| | | | NOTE 13, | | | | |
| | | | NOTE 15) | | | | |
| 74 | | 56 | 500 ms | 10⁻⁸ | N/A | 2000 ms | “Live” Uplink Streaming |
| | | | (NOTE 11, | | | | (e.g. TS 26.238 [76]) |
| | | | NOTE 15) | | | | |
| 76 | | 56 | 500 ms | 10⁻⁴ | N/A | 2000 ms | “Live” Uplink Streaming |
| | | | (NOTE 11, | | | | (e.g. TS 26.238 [76]) |
| | | | NOTE 13, | | | | |
| | | | NOTE 15) | | | | |
| 5 | Non-GBR | 10 | 100 ms | 10⁻⁶ | N/A | N/A | IMS Signalling |
| | (NOTE 1) | | NOTE 10, | | | | |
| | | | NOTE 13) | | | | |
| 6 | | 60 | 300 ms | 10⁻⁶ | N/A | N/A | Video (Buffered |
| | | | (NOTE 10, | | | | Streaming) |
| | | | NOTE 13) | | | | TCP-based (e.g., www, |
| | | | | | | | e-mail, chat, ftp, p2p |
| | | | | | | | file sharing, |
| | | | | | | | progressive video, etc.) |
| 7 | | 70 | 100 ms | 10⁻³ | N/A | N/A | Voice |
| | | | (NOTE 10, | | | | Video (Live Streaming) |
| | | | NOTE 13) | | | | Interactive Gaming |
| 8 | | 80 | 300 ms | 10⁻⁶ | N/A | N/A | Video (Buffered |
| | | | (NOTE 13) | | | | |
| 9 | | 90 | | | | | Streaming) |
| | | | | | | | TCP-based (e.g., www, |
| | | | | | | | e-mail, chat, ftp, p2p |
| | | | | | | | file sharing, |
| | | | | | | | progressive |
| | | | | | | | video, etc.) |
| 69 | | 5 | 60 ms | 10⁻⁶ | N/A | N/A | Mission Critical delay |
| (NOTE 9, | | | (NOTE 7, | | | | sensitive signalling |
| NOTE 12) | | | NOTE 8) | | | | (e.g., MC-PTT |
| | | | | | | | signalling) |
| 70 | | 55 | 200 ms | 10⁻⁶ | N/A | N/A | Mission Critical Data |
| (NOTE 12) | | | (NOTE 7, | | | | (e.g. example services |
| | | | NOTE 10) | | | | are the same as 5QI |
| | | | | | | | 6/8/9) |
| 79 | | 65 | 50 ms | 10⁻² | N/A | N/A | V2X messages (see |
| | | | (NOTE 10, | | | | TS 23.287 [121]) |
| | | | NOTE 13) | | | | |
| 80 | | 68 | 10 ms | 10⁻⁶ | N/A | N/A | Low Latency eMBB |
| | | | (NOTE 5, | | | | applications |
| | | | NOTE 10) | | | | Augmented Reality |
| 82 | Delay | 19 | 10 ms | 10⁻⁴ | 255 bytes | 2000 ms | Discrete Automation |
| | Critical | | (NOTE 4) | | | | (see TS 22.261 [2]) |
| 83 | GBR | 22 | 10 ms | 10⁻⁴ | 1354 bytes | 2000 ms | Discrete Automation |
| | | | (NOTE 4) | | (NOTE 3) | | (see TS 22.261 [2]); |
| | | | | | | | V2X messages (UE - |
| | | | | | | | RSU Platooning |
| | | | | | | | Advanced Driving: |
| | | | | | | | Cooperative Lane |
| | | | | | | | Change with low LoA. |
| | | | | | | | See TS 22.186 [111], |
| | | | | | | | TS 23.287 [121]) |
| 84 | | 24 | 30 ms | 10⁻⁵ | 1354 bytes | 2000 ms | Intelligent transport |
| | | | (NOTE 6) | | (NOTE 3) | | systems (see |
| | | | | | | | TS 22.261 [2]) |
| 85 | | 21 | 5 ms | 10⁻⁵ | 255 bytes | 2000 ms | Electricity Distribution- |
| | | | (NOTE 5) | | | | high voltage (see |
| | | | | | | | TS 22.261 [2]). |
| | | | | | | | V2X messages |
| | | | | | | | (Remote Driving. See |
| | | | | | | | TS 22.186 [111], |
| | | | | | | | NOTE 16, see |
| | | | | | | | TS 23.287 [121]) |
| 86 | | 18 | 5 ms | 10⁻⁴ | 1354 bytes | 2000 ms | V2X messages |
| | | | (NOTE 5) | | | | (Advanced Driving: |
| | | | | | | | Collision Avoidance, |
| | | | | | | | Platooning with high |
| | | | | | | | LoA. See |
| | | | | | | | TS 22.186 [111], |
| | | | | | | | TS 23.287 [121]) |

NOTE 1:
A packet which is delayed more than PDB is not counted as lost, thus not included in the PER.
NOTE 2:
It is required that default MDBV is supported by a PLMN supporting the related 5QIs.
NOTE 3:
The Maximum Transfer Unit (MTU) size considerations in clause 9.3 and Annex C of TS 23.060 [56] are also applicable. IP fragmentation may have impacts to CN PDB, and details are provided in clause 5.6.10.
NOTE 4:
A static value for the CN PDB of 1 ms for the delay between a UPF terminating N6 and a 5G-AN should be subtracted from a given PDB to derive the packet delay budget that applies to the radio interface. When a dynamic CN PDB is used, see clause 5.7.3.4.
NOTE 5:
A static value for the CN PDB of 2 ms for the delay between a UPF terminating N6 and a 5G-AN should be subtracted from a given PDB to derive the packet delay budget that applies to the radio interface. When a dynamic CN PDB is used, see clause 5.7.3.4.
NOTE 6:
A static value for the CN PDB of 5 ms for the delay between a UPF terminating N6 and a 5G-AN should be subtracted from a given PDB to derive the packet delay budget that applies to the radio interface. When a dynamic CN PDB is used, see clause 5.7.3.4.
NOTE 7:
For Mission Critical services, it may be assumed that the UPF terminating N6 is located “close” to the 5G_AN (roughly 10 ms) and is not normally used in a long distance, home routed roaming situation. Hence a static value for the CN PDBof 10 ms for the delay between a UPF terminating N6 and a 5G_AN should be subtracted from this PDB to derive the packet delay budget that applies to the radio interface.
NOTE 8:
In both RRC Idle and RRC Connected mode, the PDB requirement for these 5QIs can be relaxed (but not to a value greater than 320 ms) for the first packet(s) in a downlink data or signalling burst in order to permit reasonable battery saving (DRX) techniques.
NOTE 9:
It is expected that 5QI-65 and 5QI-69 are used together to provide Mission Critical Push to Talk service (e.g., 5QI-5 is not used for signalling). It is expected that the amount of traffic per UE will be similar or less compared to the IMS signalling.
NOTE 10:
In both RRC Idle and RRC Connected mode, the PDB requirement for these 5QIs can be relaxed for the first packet(s) in a downlink data or signalling burst in order to permit battery saving (DRX) techniques.
NOTE 11:
In RRC Idle mode, the PDB requirement for these 5QIs can be relaxed for the first packet(s) in a downlink data or signalling burst in order to permit battery saving (DRX) techniques.
NOTE 12:
This 5QI value can only be assigned upon request from the network side. The UE and any application running on the UE is not allowed to request this 5QI value.
NOTE 13:
A static value for the CN PDB of 20 ms for the delay between a UPF terminating N6 and a 5G-AN should be subtracted from a given PDB to derive the packet delay budget that applies to the radio interface.
NOTE 14:
This 5QI is not supported in this Release of the specification as it is only used for transmission of V2X messages over MBMS bearers as defined in TS 23.285 [72] but the value is reserved for future use.
NOTE 15:
For “live” uplink streaming (see TS 26.238 [76]), guidelines for PDB values of the different 5Qls correspond to the latency configurations defined in TR 26.939 [77]. In order to support higher latency reliable streaming services (above 500 ms PDB), if different PDB and PER combinations are needed these configurations will have to use non-standardised 5QIs.
NOTE 16:
These services are expected to need much larger MDBV values to be signalled to the RAN. Support for such larger MDBV values with low latency and high reliability is likely to require a suitable RAN configuration, for which, the simulation scenarios in TR 38.824 [112] may contain some guidance.

NOTE: It is preferred that a value less than 64 is allocated for any new standardised 5QI of non-GBR Resource Type. This is to allow for option 1 to be used as described in clause 5.7.1.3 (as the QFI is limited to less than 64).

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices. That is, in the first sidelink transmission configuration the first terminal device is to determine the at least one transmission resource and/or at least one transmission time occasion without consideration of a DRX state of the one or multiple second terminal devices. In the second sidelink transmission configuration, the first terminal device is to determine at least one transmission resource and/or at least one transmission time occasion with consideration of a DRX state of the one or multiple second terminal devices. The first sidelink transmission configuration may refer to, or be referred to as, a transmitter centric alternative, and the second sidelink transmission configuration may refer to, or be referred to as, a receiver centric alternative.

In accordance with an exemplary embodiment, the DRX state comprises active state or idle state.

In accordance with an exemplary embodiment, determining a sidelink transmission configuration for at least one service type or QoS requirement may further comprise: determining the first sidelink transmission configuration for a delay sensitive service type or a service associated with a critical latency requirement, e.g. delay critical V2X services, such as delay critical GBR services with 5QI values 82,83,84,85 and 86 as shown in Table 5.7.4-1 in TS 23.501 V16.5.0, and/or determining the second sidelink transmission configuration for a delay insensitive service type or a service associated with a non-critical latency requirement, e.g. non-GBR services with 5QI values 5,6,7,79 as shown in Table 5.7.4-1 in TS 23.501 V16.5.0.

As an example, for a service with critical latency requirement, e.g. a Delay Critical GBR services with 5QI values 82,83,84,85 and 86 as shown in Table 5.7.4-1 in TS 23.501 V16.5.0, the transmitter UE may choose the first sidelink transmission configuration (the transmitter centric alternative), which means the transmitter UE determines or suggests how receiver UEs may perform monitoring/receiving actions. But for another service with non-critical latency requirement, e.g. a non-GBR services with 5QI values 5,6,7,79 as shown in Table 5.7.4-1 in TS 23.501 V16.5.0, the transmitter UE may choose the second sidelink transmission configuration (the receiver centric alternative), which means the transmitter UE would check the DRX state (i.e., active or idle) of the receiver UEs.

According to the exemplary method 200 illustrated in FIG. 2, the first terminal device such as a UE can further receive a configuring message indicating the sidelink transmission configuration for the at least one service type or QoS requirement from a network node, prior to the step of determining the sidelink transmission configuration.

In accordance with an exemplary embodiment, the configuring message is received via at least one of: a Radio Resource Control (RRC) signaling; a Media Access Control (MAC) Control element (CE); a Downlink Control Information (DCI); or a System Information (SI).

In accordance with an exemplary embodiment, determining a sidelink transmission configuration for at least one service type or QoS requirement is based on the configuring message received from the network node, or based on at least one capability indicator for the first terminal device indicating whether the first terminal device supports the first sidelink transmission configuration or the second sidelink transmission configuration. The determination of the first or second sidelink transmission configuration could be done by the transmitter UE itself (e.g. the capability of the transmitter UE), or following the order from the gNB.

According to the exemplary method 200, the first terminal device such as a UE can further transmit a determination of the first sidelink transmission configuration or the second sidelink transmission configuration to the one or multiple second terminal devices or a network node.

In accordance with an exemplary embodiment, the determination is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, determining a sidelink transmission configuration for at least one service type or QoS requirement is independent of the DRX state of the first terminal device.

According to the exemplary method 200 illustrated in FIG. 2, the first terminal device such as a UE can further determine at least one transmission resource and/or at least one transmission time occasion for transmission of data associated with the at least one service type or the QoS requirement based on the sidelink transmission configuration, as shown in block 204. That is, based on the sidelink transmission configuration determined in step 202, the first terminal device, such as a UE, can determine at least one transmission resource and/or at least one transmission time occasion for transmission of data associated with the at least one service type or the QoS requirement.

In accordance with an exemplary embodiment, the step of determining at least one transmission resource and/or at least one transmission time occasion may further comprise: determining the at least one transmission resource and/or at least one transmission time occasion without consideration of a DRX state of the one or multiple second terminal devices, when the first sidelink transmission configuration is the sidelink transmission configuration determined for the service type or QoS requirement; or determining the at least one transmission resource and/or at least one transmission time occasion with consideration of a DRX state of the one or multiple second terminal devices, when the second sidelink transmission configuration is the sidelink transmission configuration determined for the service type or QoS requirement.

According to the exemplary method 200, the first terminal device such as a UE can further transmit an indication to the one or multiple second terminal devices via sidelink(s), or a network node via cellular connection. The indication at least indicates the determined at least one transmission resource and/or at least one transmission time occasion.

In accordance with an exemplary embodiment, the indication may indicate at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

In accordance with an exemplary embodiment, the indication is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, transmitting the indication to the one or multiple second terminal devices or the network node may further comprise: transmitting the indication in a first transmission time occasion according to the DRX state of the one or multiple second terminal devices.

According to the exemplary method 200, the first terminal device such as a UE can further receive a reply message from the one or multiple second terminal devices or a network node. The reply message at least indicates whether the one or multiple second terminal devices will switch to active state from idle state to receive the data.

In accordance with an exemplary embodiment, the reply message is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the first terminal device and the one or multiple second terminal devices may have the same DRX configuration. In this case, the first terminal device and one or multiple second terminal devices may not need to exchange DRX configurations.

According to the exemplary method 200, the first terminal device such as a UE can further transmit a DRX configuration for the first terminal device to the one or multiple second terminal devices or a network node; and/or receiving at least one DRX configuration for the one or multiple second terminal devices from the one or multiple second terminal devices or a network node. When the first terminal device and the one or multiple second terminal devices don't have the same DRX configuration, they may need to exchange DRX configurations.

In accordance with an exemplary embodiment, the DRX configuration is transmitted or received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, determining at least one transmission resource and/or at least one transmission time occasion may further comprise: determining the at least one transmission resource within the at least one transmission time occasion when the one or multiple second terminal devices are in active state according to the DRX configuration for the one or multiple second terminal devices.

According to the exemplary method 200 illustrated in FIG. 2, the first terminal device such as a UE can further transmit the data associated with the service type or the QoS requirement to the one or multiple second terminal devices over the sidelink, as shown in block 206. The data can be transmitted using the at least one transmission resource and/or at least one transmission time occasion determined in step 204.

In accordance with an exemplary embodiment, the step of transmitting the indication is prior to transmitting the data associated with the service type or the QoS requirement.

In accordance with an exemplary embodiment, the indication is transmitted to the one or multiple second terminal devices together with at least part of the data associated with the service type or the QoS requirement.

In accordance with an exemplary embodiment, transmitting the data associated with the service type or the QoS requirement to the one or multiple second terminal devices over the sidelink may further comprise: transmitting the data associated with the service type or the QoS requirement after a time period of transmitting the indication.

In accordance with an exemplary embodiment, the time period is pre-defined or pre-configured, or configured by a network node.

In accordance with an exemplary embodiment, the data and/or indication is transmitted via at least one of dedicated sidelink transmission, groupcast sidelink transmission or broadcast sidelink transmission.

In accordance with an exemplary embodiment, the step of determining the at least one transmission time occasion is based on the DRX state of the second terminal device, when the data and/or indication is to be transmitted via dedicated sidelink transmission.

In accordance with an exemplary embodiment, determining at least one transmission resource and/or at least one transmission time occasion may further comprise: determining the at least one transmission time occasion when at least X % of the multiple second terminal devices are in active state, when the data and/or indication is to be transmitted via groupcast sidelink transmission.

In accordance with an exemplary embodiment, determining at least one transmission resource and/or at least one transmission time occasion may further comprise: determining the at least one transmission time occasion when at least Y % of the multiple second terminal devices within a communication range of the first terminal device are in active state, when the data and/or indication is to be transmitted via broadcast sidelink transmission.

In accordance with an exemplary embodiment, the X, Y, and/or the communication range is pre-configured or configured by a network node, or determined based on the service type or the QoS requirement.

In accordance with an exemplary embodiment, all the messages could be transmitted or received between the terminal devices via sidelink(s), or transferred by the network node via cellular connection(s).

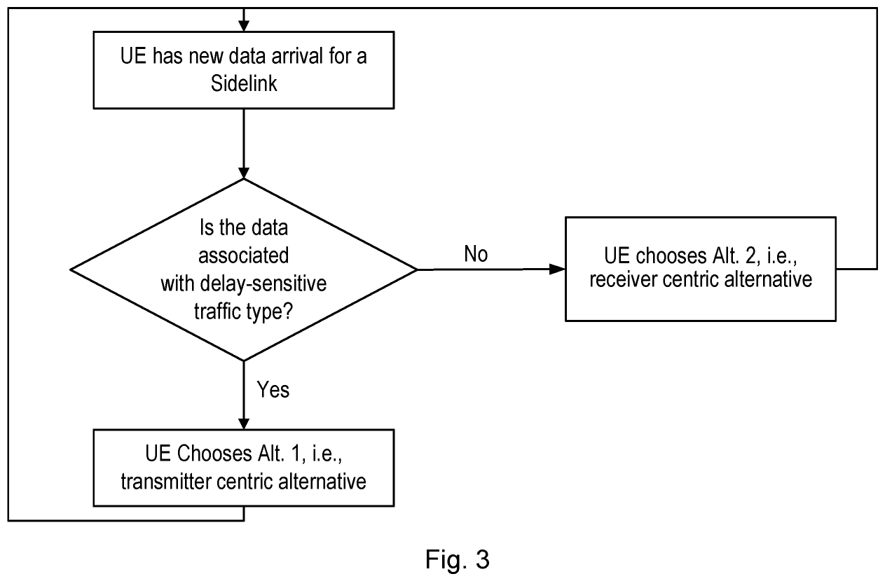

An example of the controlling procedure is illustrated in FIG. 3. When a UE has new data arrival for a sidelink, it determines whether the data associated with delay-sensitive traffic type. If yes, the UE may choose the first sidelink transmission configuration, e.g. the transmitter centric alternative; and if not, the UE may choose the second sidelink transmission configuration e.g. the receiver centric alternative.

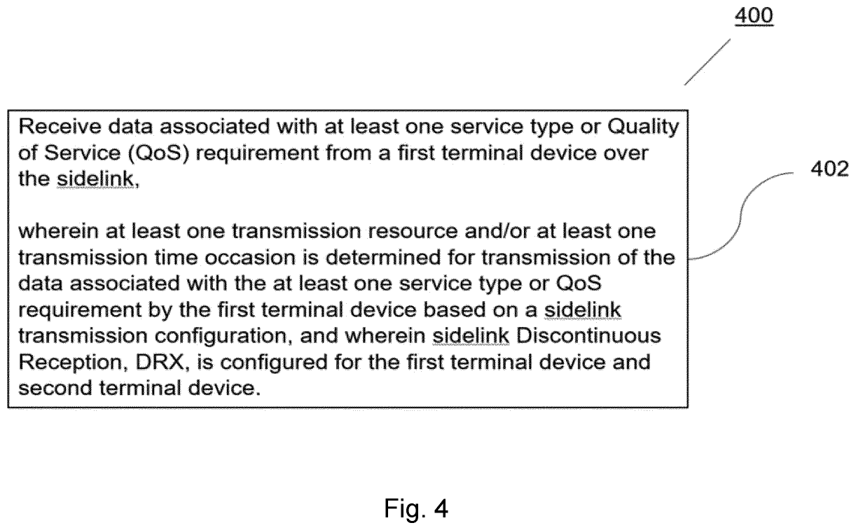

FIG. 4 is a flowchart illustrating a method 400 according to some embodiments of the present disclosure. As described in connection with FIG. 2, the method 400 illustrated in FIG. 4 may be performed by an apparatus implemented in one or multiple second terminal devices or communicatively coupled to the one or more second terminal devices. The one or multiple second terminal devices may be one or multiple receiver UEs to receive data from a transmitter UE via one or multiple sidelinks.

According to the exemplary method 400 illustrated in FIG. 4, the second terminal device such as a UE can receive data associated with at least one service type or Quality of Service (QoS) requirement from a first terminal device over the sidelink, as shown in block 402. At least one transmission resource and/or at least one transmission time occasion has been determined by the first terminal device (e.g. transmitter UE) for transmission of the data by the first terminal device based on a sidelink transmission configuration. The sidelink transmission configuration relates to how the first terminal device has determined at least one transmission resource and/or at least one transmission time occasion for transmission of data. Sidelink Discontinuous Reception (DRX) is configured for the first terminal device and second terminal device. As described in TS 23.501 V16.5.0 clause 5.7.1.1, the 5G QoS model is based on QoS Flows, a service is typically modelled as a QoS flow. The QoS characteristics for the standardized 5G QoS identifiers of different services are specified in Table 5.7.4-1 in TS 23.501 V16.5.0. The Quality of Service (QoS) requirement may comprise a latency, packet error rate (PER), mobility interruption time or reliability requirement greater than, equal to or lower than a respective threshold.

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices. That is, in the first sidelink transmission configuration the first terminal device determined the at least one transmission resource and/or at least one transmission time occasion without consideration of a DRX state of the one or multiple second terminal devices. In the second sidelink transmission configuration, the first terminal device determined at least one transmission resource and/or at least one transmission time occasion with consideration of a DRX state of the one or multiple second terminal devices. The first sidelink transmission configuration may refer to a transmitter centric alternative, and the second sidelink transmission configuration may refer to a receiver centric alternative.

In accordance with an exemplary embodiment, the first sidelink transmission configuration is determined for a delay sensitive service type or a service associated with a critical latency requirement, e.g. delay critical GBR services with 5QI values 82,83,84,85 and 86 as shown in Table 5.7.4-1 in TS 23.501 V16.5.0, and/or the second sidelink transmission configuration is determined for a delay insensitive service type or a service associated with a non-critical latency requirement, e.g. non-GBR services with 5QI values 5,6,7,79 as shown in Table 5.7.4-1 in TS 23.501 V16.5.0.

As an example, for a service with critical latency requirement, e.g. delay critical GBR services with 5QI values 82,83,84,85 and 86 as shown in Table 5.7.4-1 in TS 23.501 V16.5.0, the transmitter UE may choose the first sidelink transmission configuration (the transmitter centric alternative), which means the transmitter UE determines or suggests how receiver UEs may perform monitoring/receiving actions. But for another service with non-critical latency requirement, e.g. non-GBR services with 5QI values 5,6,7,79 as shown in Table 5.7.4-1 in TS 23.501 V16.5.0, the transmitter UE may choose the second sidelink transmission configuration (the receiver centric alternative), which means the transmitter UE would check the DRX state (i.e., active or idle) of the receiver UEs.

In accordance with an exemplary embodiment, the DRX state comprises active state or idle state.

According to the exemplary method 400 illustrated in FIG. 4, the second terminal device such as a UE can further receive a determination of the first sidelink transmission configuration or the second sidelink transmission configuration from the first terminal device or a network node.

In accordance with an exemplary embodiment, the determination is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the determination of the sidelink transmission configuration for at least one service type or QoS requirement is independent of the DRX state of the first terminal device.

According to the exemplary method 400 illustrated in FIG. 4, the second terminal device such as a UE can further receive an indication from the first terminal device or a network node. The indication at least indicates the determined at least one transmission resource and/or at least one transmission time occasion.

In accordance with an exemplary embodiment, the indication indicates at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

In accordance with an exemplary embodiment, the indication is received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, the data and/or indication is received via at least one of dedicated sidelink transmission, groupcast sidelink transmission or broadcast sidelink transmission.

In accordance with an exemplary embodiment, the step of receiving the indication is prior to receiving the data associated with the service type or the QoS requirement.

In accordance with an exemplary embodiment, the indication is received from the first terminal device or a network node together with at least part of the data associated with the service type or the QoS requirement.

In accordance with an exemplary embodiment, the step of receiving data associated with the service type or the QoS requirement is after a time period of receiving the indication.

In accordance with an exemplary embodiment, the time period is pre-defined or pre-configured, or configured by a network node.

In accordance with an exemplary embodiment, the indication is transmitted from the first terminal device or the network node in a first transmission time occasion according to the DRX state of the second terminal device.

In accordance with an exemplary embodiment, the first terminal device and the one or multiple second terminal devices have a same DRX configuration. In this case, the first terminal device and one or multiple second terminal devices may not need to exchange DRX configurations.

According to the exemplary method 400 illustrated in FIG. 4, the second terminal device such as a UE can further receive a DRX configuration for the first terminal device from the first terminal device or a network node; and/or transmitting a DRX configuration for second terminal device to the first terminal device or a network node. When the first terminal device and the one or multiple second terminal devices don't have the same DRX configuration, they may need to exchange DRX configurations.

In accordance with an exemplary embodiment, the DRX configuration is transmitted or received via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, at least one transmission resource during the at least one transmission time occasion when the second terminal device is in active state according to a DRX configuration for the second terminal device is determined.

In accordance with an exemplary embodiment, at least one transmission time occasion based on the DRX state of the second terminal device is determined, when the data and/or indication is to be received via dedicated sidelink transmission.

According to the exemplary method 400 illustrated in FIG. 4, the second terminal device such as a UE can further transmit a reply message to the first terminal device or a network node. The reply message at least indicates whether the one or multiple second terminal devices will switch to active state from idle state to receive the data.

In accordance with an exemplary embodiment, the reply message is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

According to the exemplary method 400 illustrated in FIG. 4, the second terminal device such as a UE can further switch to active state from idle state at the indicated at least one transmission resource and/or at least one transmission time occasion, or switch to active state from idle state according to the DRX configuration for the second terminal device.

According to the exemplary method 400 illustrated in FIG. 4, the second terminal device such as a UE can further receive a configuring message indicating the sidelink transmission configuration for the at least one service type or QoS requirement from a network node.

In accordance with an exemplary embodiment, the configuring message is received via at least one of: a Radio Resource Control (RRC) signaling; a Media Access Control (MAC) Control element (CE); a Downlink Control Information (DCI); or a System Information (SI).

In accordance with an exemplary embodiment, the step of receiving the configuring message indicating the sidelink transmission configuration for the at least one service type or QoS requirement from a network node is prior to the first terminal device determining the sidelink transmission configuration.

In accordance with an exemplary embodiment, the configuring message is received via at least one of: a Radio Resource Control (RRC) signaling; a Media Access Control (MAC) Control element (CE); a Downlink Control Information (DCI); or a System Information (SI).

In accordance with an exemplary embodiment, determining a sidelink transmission configuration for at least one service type or QoS requirement is based on the configuring message received from the network node, or based on at least one capability indicator for the first terminal device indicating whether the first terminal device supports the first sidelink transmission configuration or the second sidelink transmission configuration.

According to the exemplary method 200, the first terminal device such as a UE can further transmit a determination of the first sidelink transmission configuration or the second sidelink transmission configuration to the one or multiple second terminal devices or a network node.

In accordance with an exemplary embodiment, the determination is transmitted via at least one of: a Physical Sidelink Common Control Channel (PSCCH); a Physical Sidelink Shared Channel (PSSCH); a PC5-Radio Resource Control (RRC) signaling; a PC5-Media Access Control (MAC) Control element (CE); or a cellular connection.

In accordance with an exemplary embodiment, determining a sidelink transmission configuration for at least one service type or QoS requirement is independent of the DRX state of the first terminal device.

In accordance with an exemplary embodiment, all the messages could be transmitted or received between the terminal devices via sidelink(s), or transferred by the network node via cellular connection(s).

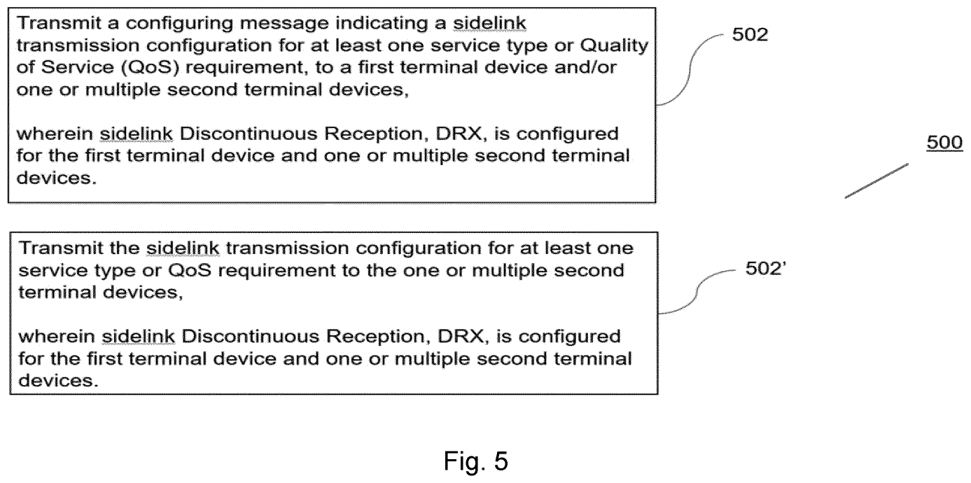

FIG. 5 is a flowchart illustrating a method 500 according to some embodiments of the present disclosure. As described in connection with FIGS. 2 and 4, the method 500 illustrated in FIG. 5 may be performed by an apparatus implemented in a network node or communicatively coupled to a network node. In accordance with an exemplary embodiment, the network node such as a gNB may transmit or forward sidelink transmission configuration to a transmitter UE and/or one or multiple receiver UEs.

According to the exemplary method 500 illustrated in FIG. 5, the network node such as a gNB can transmit a configuring message indicating a sidelink transmission configuration for at least one service type or Quality of Service (QoS) requirement, to a first terminal device and/or one or multiple second terminal devices, as shown in block 502, or transmit the sidelink transmission configuration for at least one service type or QoS requirement to the one or multiple second terminal devices, as shown in block 502′. The sidelink transmission configuration relates to how the first terminal device is to determine at least one transmission resource and/or at least one transmission time occasion for transmission of data. Sidelink Discontinuous Reception (DRX) is configured for the first terminal device and one or multiple second terminal devices.

In accordance with an exemplary embodiment, the sidelink transmission configuration comprises at least one of: a first sidelink transmission configuration that the first terminal device determines at least one transmission resource and/or at least one transmission time occasion without consideration of a DRX state of the one or multiple second terminal devices; or a second sidelink transmission configuration that the first terminal device determines at least one transmission resource and/or at least one transmission time occasion with consideration of a DRX state of the one or multiple second terminal devices. That is, in the first sidelink transmission configuration the first terminal device is to determine the at least one transmission resource and/or at least one transmission time occasion without consideration of a DRX state of the one or multiple second terminal devices. In the second sidelink transmission configuration, the first terminal device is to determine at least one transmission resource and/or at least one transmission time occasion with consideration of a DRX state of the one or multiple second terminal devices. The first sidelink transmission configuration may refer to a transmitter centric alternative, and the second sidelink transmission configuration may refer to a receiver centric alternative.

According to the exemplary method 500 illustrated in FIG. 5, the network node such as a gNB can further receive an indication from the first terminal device and/or transmit the indication to the one or multiple second terminal devices. The indication at least indicates at least one transmission resource and/or at least one transmission time occasion.

In accordance with an exemplary embodiment, the indication indicates at least one of: one or multiple resources in frequency; one or multiple resources in time; one or multiple transmission time occasions for initial transmissions and/or one or multiple transmission time occasions for one or multiple retransmissions; at least one Hybrid Automatic Repeat Request (HARQ) process identity (ID) for the at least one transmission time occasion; at least one Redundancy version (RV) value for the at least one transmission occasion; at least one New data indicator (NDI) of the HARQ process assigned for the at least one transmission time occasion; or at least one of the service type, Logical channel ID, Logical channel group (LCG) or priority index for the data to be transmitted during the at least one transmission time occasion.

According to the exemplary method 500 illustrated in FIG. 5, the network node such as a gNB can further receive a reply message from the one or multiple second terminal devices, and/or transmit the reply message to the first terminal devices. The reply message at least indicates whether the one or multiple second terminal devices will switch to active state from idle state to receive data associated with the service type or the QoS requirement from the first terminal device over the sidelink.

In accordance with an exemplary embodiment, the indication is received and/or transmitted via a cellular connection, and/or the reply message is transmitted and/or received via a cellular connection.

According to the exemplary method 500 illustrated in FIG. 5, the network node such as a gNB can further perform at least one of: receiving a DRX configuration for the first terminal device from the first terminal device; transmitting a DRX configuration for the first terminal device to one or multiple second terminal devices; receiving at least one DRX configuration for the one or multiple second terminal devices from the one or multiple second terminal devices; or transmitting the at least one DRX configuration for the one or multiple second terminal devices to the first terminal device. The network node could help to exchange DRX configurations between terminal devices, especially when they are different.

In accordance with an exemplary embodiment, the configuring message and/or the sidelink transmission configuration is transmitted via at least one of: a Radio Resource Control (RRC) signaling; a Media Access Control (MAC) Control element (CE); a Downlink Control Information (DCI); or a System Information (SI).

According to the exemplary method 500 illustrated in FIG. 5, the network node such as a gNB can further determine the configuring message indicating sidelink transmission configuration for at least one service type or QoS requirement; or receive the sidelink transmission configuration for at least one service type or QoS requirement from the first terminal device. The network node could instruct the first terminal device to determine the sidelink transmission configuration, or just forward the determined sidelink transmission configuration. The determination of the first or second sidelink transmission configuration could be done by the transmitter UE itself (e.g. the capability of the transmitter UE), or following the order from the gNB.

According to the exemplary method 500 illustrated in FIG. 5, the network node such as a gNB can further receive a determination of the first sidelink transmission configuration or the second sidelink transmission configuration from the first terminal device; and/or transmit the determination of the first sidelink transmission configuration or the second sidelink transmission configuration to the one or multiple second terminal devices. The network node could forward the determination from the first terminal device to the one or multiple second terminal devices.

It will be realized that parameters, variables and settings related to the determination, transmission and reception described herein are just examples. Other suitable network settings, the associated configuration parameters and the specific values thereof may also be applicable to implement the proposed methods.

The proposed solution according to one or more exemplary embodiments can achieve at least one of below benefits: achieve a good balance between sidelink energy saving and QoS satisfaction of the transmissions; reduced latency for delay sensitive transmissions. For example, the delay critical service would then have better QoS satisfaction. In case of automotive driving, due to reduced latency, both driver's driving experience and road safety will be improved.

The various blocks shown in FIG. 2, FIG. 4 and FIG. 5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

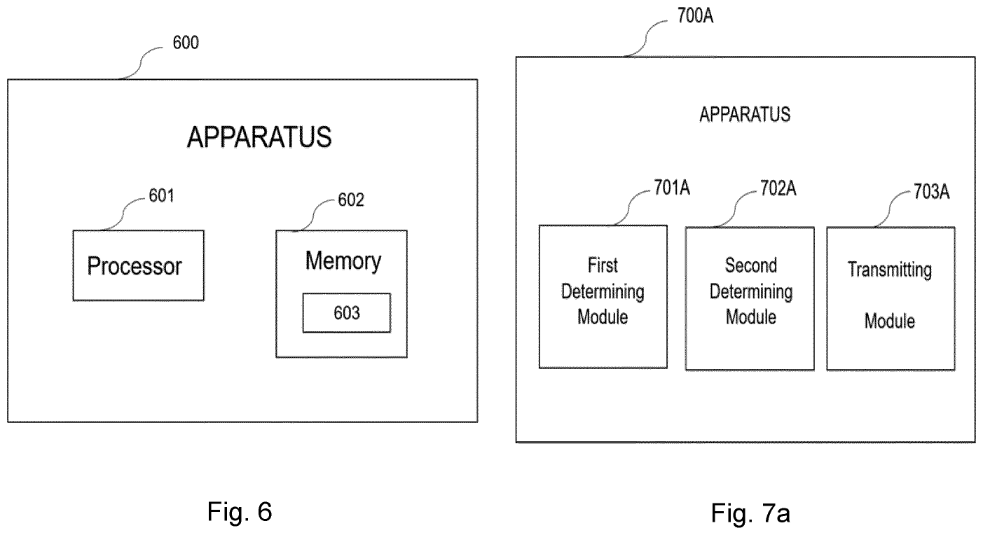

FIG. 6 is a block diagram illustrating an apparatus 600 according to various embodiments of the present disclosure. As shown in FIG. 6, the apparatus 600 may comprise one or more processors such as one or more processors 601, and one or more memories such as memory 602, storing computer program code 603. The memory 602 may be non-transitory machine/processor/computer readable storage medium. In accordance with some exemplary embodiments, the apparatus 600 may be implemented as an integrated circuit chip or module that can be plugged or installed into a terminal device as described with respect to FIG. 2 or FIG. 4, and a network node as described with respect to FIG. 5.

In some implementations, the one or more memories 602, and the computer program code 603, may be configured to, with the one or more processors 601, cause the apparatus 600 at least to perform any operation of the method as described in connection with FIG. 2, FIG. 4 and FIG. 5. In other implementations, the one or more memories 602, and the computer program code 603, may be configured to, with the one or more processors 601, cause the apparatus 600 at least to perform any operation of the method as described in connection with FIG. 2, FIG. 4 and FIG. 5.

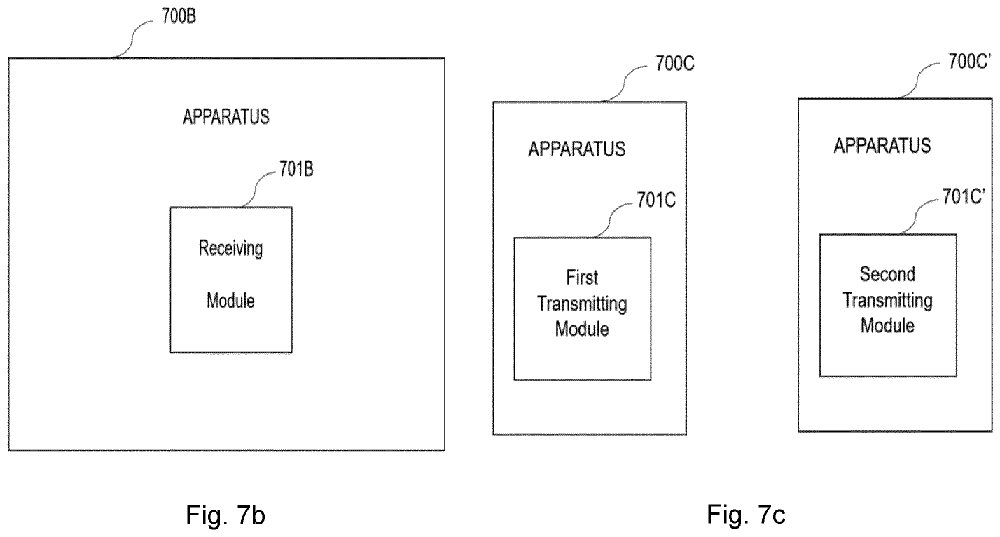

FIG. 7A is a block diagram illustrating an apparatus 700A according to some embodiments of the present disclosure. As shown in FIG. 7A, the apparatus 700A may comprise a first determining module 701A, a second determining module 702A and a transmitting module 703A. In an exemplary embodiment, the apparatus 700A may be implemented in a first terminal device such as a transmitter UE. The first determining module 701A may be operable to carry out the operation in block 202, the second determining module 702A may be operable to carry out the operation in block 204, and the transmitting module 703A may be operable to carry out the operation in block 206. Optionally, the first determining module 701A, the second determining module 702A and/or the transmitting module 703A may be operable to carry out more or less operations to implement the proposed methods according to the exemplary embodiments of the present disclosure.

FIG. 7B is a block diagram illustrating an apparatus 700B according to some embodiments of the present disclosure. As shown in FIG. 7B, the apparatus 700B may comprise a receiving module 701B. In an exemplary embodiment, the apparatus 700B may be implemented in one or multiple second terminal devices such as receiver UEs. The receiving module 701B may be operable to carry out the operation in block 402. Optionally, receiving module 701B may be operable to carry out more or less operations to implement the proposed methods according to the exemplary embodiments of the present disclosure.

FIG. 7C is a block diagram illustrating an apparatus 700C and 700C′ according to some embodiments of the present disclosure. As shown in FIG. 7C, the apparatus 700C and 700C′ may comprise a first transmitting module 701C and a second transmitting module 701C′ respectively. In an exemplary embodiment, the apparatus 700C may be implemented in a network node such as a gNB. The first transmitting module 701C and the second transmitting module 701C′ may be operable to carry out the operation in block 502 and 502′ respectively. Optionally, the first transmitting module 701C and the second transmitting module 701C′ may be operable to carry out more or less operations to implement the proposed methods according to the exemplary embodiments of the present disclosure.

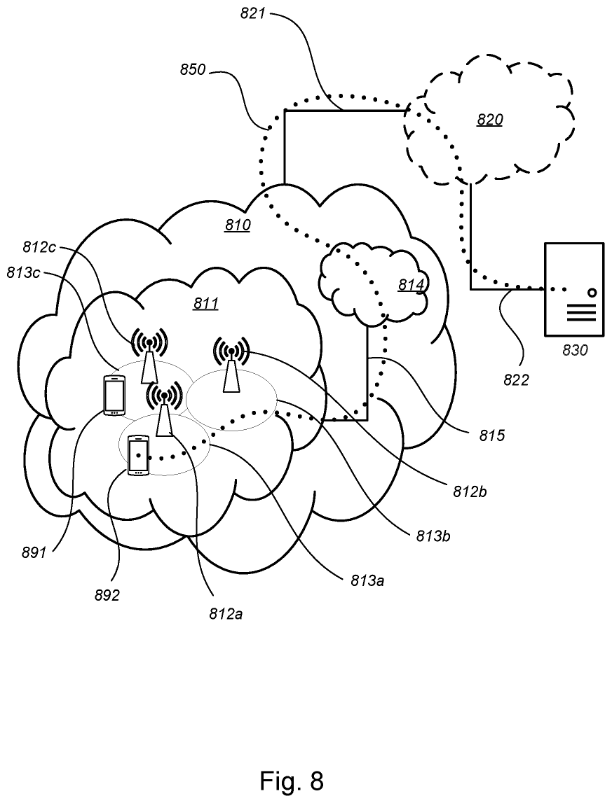

FIG. 8 is a block diagram illustrating a telecommunication network connected via an intermediate network to a host computer in accordance with some embodiments of the present disclosure.

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 881 located in a coverage area 813c is configured to wirelessly connect to, or be paged by, the corresponding base station 812c. A second UE 882 in a coverage area 813a is wirelessly connectable to the corresponding base station 812a. While a plurality of UEs 881, 882 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between the connected UEs 881, 882 and the host computer 830. The connectivity may be described as an over-the-top (OTT) connection 850. The host computer 830 and the connected UEs 881, 882 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 881. Similarly, the base station 812 need not be aware of the future routing of an outgoing uplink communication originating from the UE 881 towards the host computer 830.

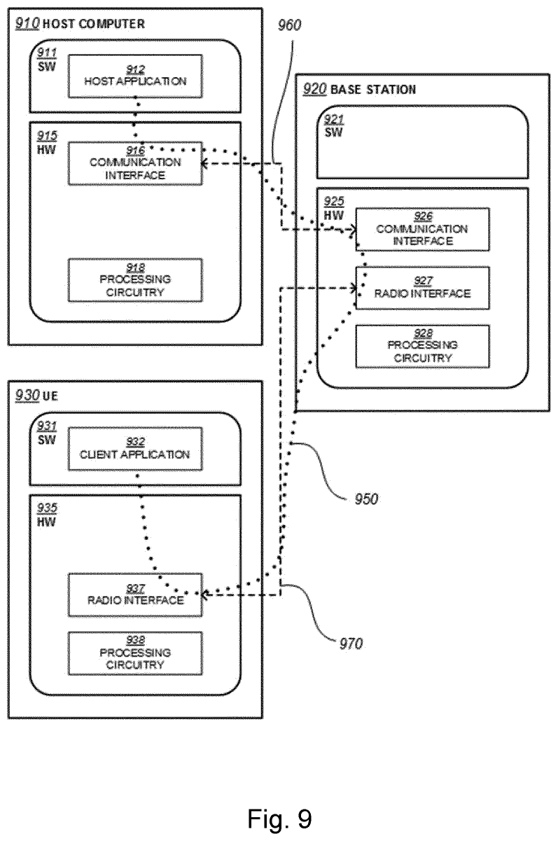

FIG. 9 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 9. In a communication system 900, a host computer 99 comprises hardware 915 including a communication interface 916 configured to set up and maintain a wired or wireless connection with an interface of a different communication device of the communication system 900. The host computer 99 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 99 further comprises software 911, which is stored in or accessible by the host computer 99 and executable by the processing circuitry 918. The software 911 includes a host application 912. The host application 912 may be operable to provide a service to a remote user, such as UE 930 connecting via an OTT connection 950 terminating at the UE 930 and the host computer 99. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 99 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 9) served by the base station 920. The communication interface 926 may be configured to facilitate a connection 960 to the host computer 99. The connection 960 may be direct or it may pass through a core network (not shown in FIG. 9) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 99. In the host computer 99, an executing host application 912 may communicate with the executing client application 932 via the OTT connection 950 terminating at the UE 930 and the host computer 99. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 99, the base station 920 and the UE 930 illustrated in FIG. 9 may be similar or identical to the host computer 930, one of base stations 912a, 912b, 912c and one of UEs 991, 992 of FIG. 9, respectively. This is to say, the inner workings of these entities may be as shown in FIG. 9 and independently, the surrounding network topology may be that of FIG. 9.

In FIG. 9, the OTT connection 950 has been drawn abstractly to illustrate the communication between the host computer 99 and the UE 930 via the base station 920, without explicit reference to any intermediary devices and the precise routing of messages via these devices. Network infrastructure may determine the routing, which it may be configured to hide from the UE 930 or from the service provider operating the host computer 99, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 99 and the UE 930, in response to variations in the measurement results. The measurement procedure and/or the network functionality for reconfiguring the OTT connection 950 may be implemented in software 911 and hardware 915 of the host computer 99 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 99's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

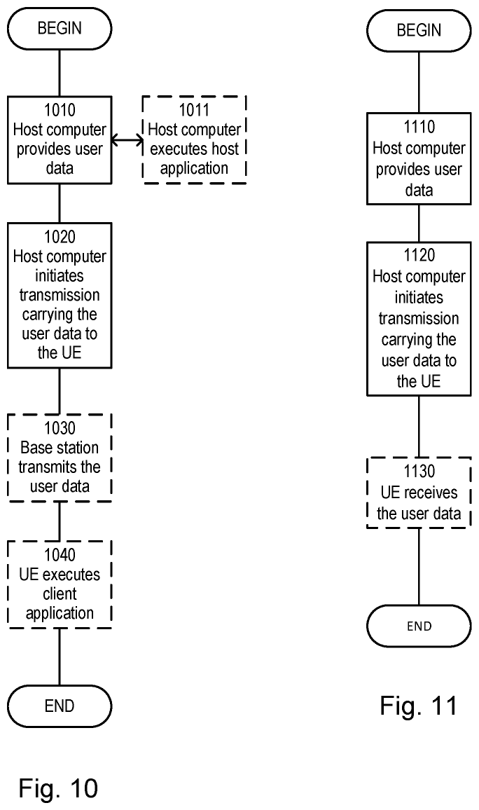

FIG. 10 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 10 will be included in this section. In step 1010, the host computer provides user data. In substep 1010 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

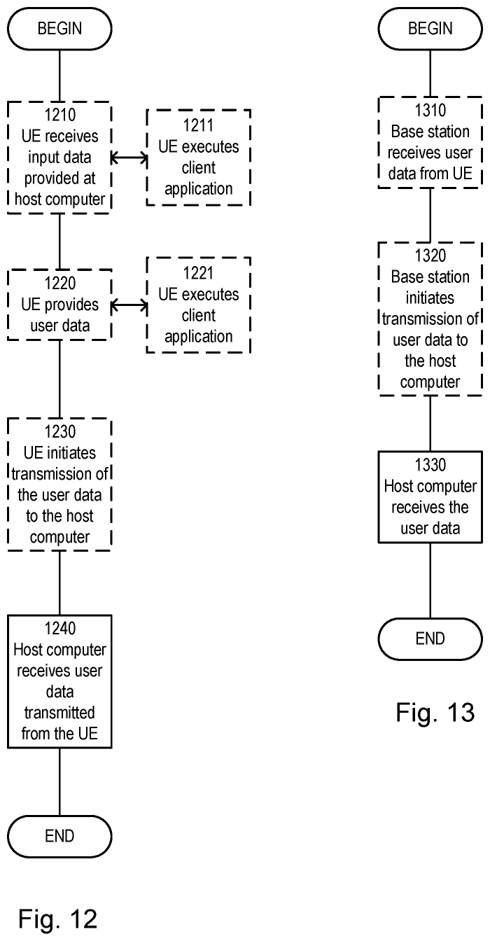

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

Hereinafter, the solutions will be further described as follows.

A controlling mechanism for a Sidelink based transmission in case that Sidelink DRX is applied, is proposed for a transmitter UE. In the controlling mechanism, the transmitter UE controls the Sidelink transmission considering the latency requirements associated with the transmission. If the transmission is associated with critical latency requirements, the transmitter UE determines the transmission occasions for its subsequent transmissions and informs the relevant information to the receivers UEs. If the transmission is not associated with critical latency requirements, the transmitter UE determines the transmission occasions for its subsequent transmissions considering the DRX states of receiver UEs. In other words, the transmitter UE performs transmissions to receiver UEs only when they are in active state according to their DRX configurations.

At least one of below benefits are achieved with the proposed controlling mechanism: achieve a good balance between Sidelink energy saving and QoS satisfaction of the transmissions; reduced latency for delay sensitive transmissions.

In the first embodiment, there are two different alternatives defined for controlling NR Sidelink transmission in case that Sidelink DRX is configured for both the transmitter and the receivers. The term PC5-MAC CE is used in the below embodiments. Such MAC CE is transmitted by a UE to other UEs via a sidelink transmission (in unicast or groupcast or broadcast fashion) indicating certain control information. Such MAC CE is different from the existing MAC CE, since the existing MAC CE is used to convey control information between a UE and a gNB. The term PC5 MAC CE may also interchangeably called as other names such as control command, or control order etc. The embodiment is not restricted by terms.

Alt. 1: Transmitter centric alternative

In this alternative, for a Sidelink transmission, the transmitter UE determines or suggests how receiver UEs may perform monitoring/receiving actions.

The transmitter UE may send signaling to receiver UEs informing them of the information on the resources which the transmitter UE will use for subsequent transmissions. The information may contain at least one of the below elements for one or multiple subsequent transmissions:
One or multiple resources in frequency (i.e. transmission occasion in frequency);
One or multiple resources in time (i.e. transmission occasion in time);
Among the transmission occasions, which occasions will be used for initial transmissions, and which occasions will be used for retransmissions;
HARQ process ID for each transmission occasion;
Redundancy version (RV) value for each transmission occasion
New data indicator (NDI) bit of the HARQ process assigned for each transmission occasion;
Service type/Logical channel ID/Logical channel group (LCG)/priority index of the data which will be transmitted during each transmission occasion;

A receiver UE receives the information. The receiver UE may take one of the below options:
Option 1: accept the suggestion from the transmitter UE. At the indicated resource region and the indicated transmission time occasion, the UE switches to active state if the UE is in idle state. If the receiver UE is configured with a Sidelink DRX configuration, the UE will switch to active state at the indicated resource region and the indicated transmission time occasion regardless if the DRX configuration determines the UE to be active or idle at the indicated transmission time occasion.
Option 2: reject the suggestion from the transmitter UE and perform actions as if the information has not been received.

For either of the above options, the receiver UE may send a reply message to the transmitter UE indicating the selected option.

The information from the transmitter UE may be sent on PSCCH as one part of a SCI to receiver UEs. Alternatively, the information may be sent on PSSCH. In this case, the information may be carried in a PC5-RRC signaling message or a PC5-MAC CE. The transmission may be any of the types: dedicated transmission, group cast or broadcast.

The reply message from a receiver UE may be transmitted on the PSSCH of the reverse link. In this case, the information may be carried in a PC5-RRC signaling message or a PC5-MAC CE.

Alternatively, in certain scenarios, the receiver UEs may be forced to accept the suggestion on the controlling alternative indicated by the transmitter UE. In an example, if configured by the gNB, a receiver UE needs to always comply with the order (e.g. signaling sent by the transmitter UE in Transmitter centric alternative) sent by the transmitter UE. In another example, a Sidelink UE may be configured with a rank indicator. In this way, a UE configured with a low rank indicator needs to follow the order issued by another UE with a high rank indicator. In yet another example, a UE may be configured with a list of IDs of other UEs. The UE needs to follow the orders issued by those UEs.

Alternatively, either the information from the transmitter UE or the reply message from a receiver UE may be transmitted over the cellular connection. In this case, upon reception of the information, the gNB will forward the information or the reply to the intended UEs.

It is important to ensure reliable transmission for the aforementioned information by a transmitter UE, since the receiver UEs need to organize their active slots/time occasions according to the received information. The information also needs to be signaled to the receiver UEs prior to the corresponding transmissions being initiated by the transmitter UE. Therefore, the transmitter UE may select a first slot/time occasion according to the knowledge of DRX state of the receiver UEs. In other words, the first slot/time occasion is selected when the receiver UEs are active. The transmitter UE transmits the aforementioned information in the first time occasion, optionally together with some UE data. After sending the information to the receiver UEs, the transmitter UE can start the subsequent transmissions after a time period which allows the receivers UEs to process the received information. The time period may be configured by the gNB, alternatively the time period may be hard coded.

Alt. 2: Receiver centric alternative

As soon as the transmitter UE has data in the buffer, the transmitter UE would check the DRX state (i.e., active or idle) of the receiver UEs. There may be several options for the transmitter UE to obtain the knowledge of the DRX state of the receiver UEs. The transmitter UE may apply at least one of the options:
Option 1: the transmitter UE and one or multiple receiver UEs have the same DRX configuration. In this case, the transmitter UE and these receiver UEs most probably have the same DRX state.
Option 2: the transmitter UE and any receiver UE may exchange their DRX state between each other. The DRX state information may be carried in a PC5-MAC CE or PC5-RRC signaling on PSSCH.

Based on the DRX information of receiver UEs, the transmitter UE selects resources for subsequent transmissions during the selected coming slots/time occasions when the receiver UEs are active.

In case of a dedicated Sidelink transmission, there is only one receiver UE. The transmitter UE selects the slots/time occasions for this receiver UE based on DRX information of this UE.

In case of a group cast Sidelink transmission, the transmitter UE may select slots/time occasions during which at least X % of the group UEs are active. X may be configured by the gNB or predefined/preconfigured.

In case of a broadcast Sidelink transmission, the transmitter UE may select slots/time occasions during which at least Y % of the UEs within certain communication range are active. Y may be configured by the gNB. The communication range associated with the Sidelink transmission may be also configured by the gNB or predefined/preconfigured. Alternatively, the communication range associated with the Sidelink transmission may be determined based on the QoS requirements of the services/traffic types associated with the transmission.

A UE with data available can apply at least one of the above alternatives to perform a Sidelink based transmission.

In the second embodiment, for the first embodiment, which alternative is applied by a UE, is selected by the UE depending on what traffic type or QoS requirement is associated with the transmission.

For a delay sensitive traffic type, or a service associated with a tight latency requirement, the UE applies Alt. 1, otherwise, for a delay insensitive traffic type or a service associated with a relaxed latency requirement, the UE applies Alt. 2.

In the third embodiment, for a Sidelink transmission, which alternative should be applied by a UE, is configured by the gNB. The configuration is signaled to the UE by the gNB via RRC signaling, MAC CE or DCI. Alternatively, the configuration is signaled to the UE by the gNB via system information (i.e., system information for cellular link or system information for sidelink).

In the fourth embodiment, for a Sidelink transmission, the transmitter signals its transmission alternative (i.e., Alt. 1 or Alt. 2 in the first embodiment) to the receivers.

The signaling from the transmitter UE may be sent on PSCCH as one part of a SCI to receiver UEs. Alternatively, the signaling may be sent on PSSCH. In this case, the signaling may be carried in a PC5-RRC signaling message or a PC5-MAC CE.

In the fifth embodiment, a UE capability bit is defined for indicating that the UE supports Alt. 1 for controlling a Sidelink transmission. Another UE capability bit is defined for indicating that the UE supports Alt. 2 for controlling a Sidelink transmission.

In the sixth embodiment, for a Sidelink transmission, the time at which the transmission can be performed by the transmitter UE is not affected by its own DRX state.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

The following numbered statements set out various exemplary, non-limiting examples of the techniques described herein.

1. A method (200) implemented at a first terminal device, comprising:
determining (202) a sidelink transmission configuration for at least one service type or Quality of Service, QoS, requirement, wherein sidelink Discontinuous Reception, DRX, is configured for the first terminal device and one or multiple second terminal devices;
determining (204) at least one transmission resource and/or at least one transmission time occasion for transmission of data associated with the at least one service type or the QoS requirement based on the sidelink transmission configuration; and
transmitting (206) the data associated with the service type or the QoS requirement to the one or multiple second terminal devices over the sidelink.
   2. The method according to statement 1, wherein the sidelink transmission configuration comprises at least one of:
a first sidelink transmission configuration that the first terminal device determines at least one transmission resource and/or at least one transmission time occasion without consideration of a DRX state of the one or multiple second terminal devices; or
a second sidelink transmission configuration that the first terminal device determines at least one transmission resource and/or at least one transmission time occasion with consideration of a DRX state of the one or multiple second terminal devices.
   3. The method according to statement 1 or 2, wherein determining (204) at least one transmission resource and/or at least one transmission time occasion further comprises:
determining the at least one transmission resource and/or at least one transmission time occasion without consideration of a DRX state of the one or multiple second terminal devices, when the first sidelink transmission configuration is determined for the service type or QoS requirement; or
determining the at least one transmission resource and/or at least one transmission time occasion with consideration of a DRX state of the one or multiple second terminal devices, when the second sidelink transmission configuration is determined for the service type or QoS requirement.
   4. The method according to statement 2 or 3, wherein the DRX state comprises active state or idle state.
   5. The method according to any of statements 1-4, further comprising: transmitting an indication to the one or multiple second terminal devices or a network node, wherein the indication at least indicates the determined at least one transmission resource and/or at least one transmission time occasion.
   6. The method according to statement 5, wherein the indication indicates at least one of:
one or multiple resources in frequency;
one or multiple resources in time;
one or multiple transmission time occasions for initial transmissions and/or one or multiple transmission time occasions for one or multiple retransmissions;
at least one Hybrid Automatic Repeat Request, HARQ, process identity, ID, for the at least one transmission time occasion;
at least one Redundancy version, RV, value for the at least one transmission occasion;
at least one New data indicator, NDI, of the HARQ process assigned for the at least one transmission time occasion; or
at least one of the service type, Logical channel ID, Logical channel group, LCG, or priority index for the data to be transmitted during the at least one transmission time occasion.
   7. The method according to statement 5 or 6, further comprising: receiving a reply message from the one or multiple second terminal devices or a network node, wherein the reply message at least indicates whether the one or multiple second terminal devices will switch to active state from idle state to receive the data.
   8. The method according to any of statements 5-7, wherein the indication is transmitted via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   9. The method according to any of statements 1-8, wherein the data and/or indication is transmitted via at least one of dedicated sidelink transmission, groupcast sidelink transmission or broadcast sidelink transmission.
   10. The method according to any of statements 7-9, wherein the reply message is received via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   11. The method according to any of statements 5-10, wherein transmitting the indication to the one or multiple second terminal devices or the network node further comprises: transmitting the indication in a first transmission time occasion according to the DRX state of the one or multiple second terminal devices.
   12. The method according to any of statements 5-11, wherein transmitting the indication to the one or multiple second terminal devices or the network node further comprises: transmitting the indication prior to transmitting (204) the data associated with the service type or the QoS requirement.
   13. The method according to any of statements 5-12, wherein the indication is transmitted to the one or multiple second terminal devices together with at least part of the data associated with the service type or the QoS requirement.
   14. The method according to any of statements 5-13, wherein transmitting (206) the data associated with the service type or the QoS requirement to the one or multiple second terminal devices over the sidelink further comprises: transmitting (206) the data associated with the service type or the QoS requirement after a time period of transmitting the indication.
   15. The method according to statement 14, wherein the time period is pre-configured.
   16. The method according to any of statements 1-15, wherein the first terminal device and the one or multiple second terminal devices have a same DRX configuration.
   17. The method according to any of statements 1-16, further comprising: transmitting a DRX configuration for the first terminal device to the one or multiple second terminal devices or a network node; and/or
receiving at least one DRX configuration for the one or multiple second terminal devices from the one or multiple second terminal devices or a network node.
   18. The method according to statement 17, wherein the DRX configuration is transmitted or received via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   19. The method according to any of statements 1-18, wherein determining (204) at least one transmission resource and/or at least one transmission time occasion further comprises:
determining the at least one transmission resource during the at least one transmission time occasion when the one or multiple second terminal devices are in active state according to the DRX configuration for the one or multiple second terminal devices.
   20. The method according to any of statements 1-19, wherein determining (204) at least one transmission resource and/or at least one transmission time occasion further comprises:
determining the at least one transmission time occasion based on the DRX state of the second terminal device, when the data and/or indication is to be transmitted via dedicated sidelink transmission.
   21. The method according to any of statements 1-20, wherein determining (204) at least one transmission resource and/or at least one transmission time occasion further comprises:
determining the at least one transmission time occasion when at least X % of the multiple second terminal devices are in active state, when the data and/or indication is to be transmitted via groupcast sidelink transmission.
   22. The method according to any of statements 1-21, wherein determining (204) at least one transmission resource and/or at least one transmission time occasion further comprises:
determining the at least one transmission time occasion when at least Y % of the multiple second terminal devices within a communication range of the first terminal deviceare in active state, when the data and/or indication is to be transmitted via broadcast sidelink transmission.
   23. The method according to statement 21 or 22, wherein the X, Y, and/or the communication range is pre-configured or configured by a network node, or determined based on the service type or the QoS requirement.
   24. The method according to any of statements 1-23, wherein determining (202) a sidelink transmission configuration for at least one service type or QoS requirement further comprises:
determining the first sidelink transmission configuration for a delay sensitive service type or a service associated with a critical latency requirement; and/or
determining the second sidelink transmission configuration for a delay insensitive service type or a service associated with a non-critical latency requirement.
   25. The method according to any of statements 1-24, further comprising: receiving a configuring message indicating the sidelink transmission configuration for the at least one service type or QoS requirement from a network node.
   26. The method according to statement 25, wherein the configuring message is received via at least one of:
a Radio Resource Control, RRC, signaling;
a Media Access Control, MAC, Control element, CE;
a Downlink Control Information, DCI; or
a System Information, SI.
   27. The method according to statement 25 or 26, wherein determining (202) a sidelink transmission configuration for at least one service type or QoS requirement is based on the configuring message received from the network node, or based on at least one capability indicator for the first terminal device indicating whether the first terminal device supports the first sidelink transmission configuration or the second sidelink transmission configuration.
   28. The method according to any of statements 2-27, further comprising: transmitting a determination of the first sidelink transmission configuration or the second sidelink transmission configuration to the one or multiple second terminal devices or a network node.
   29. The method according to statement 28, wherein the determination is transmitted via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   30. The method according to any of statements 1-29, wherein determining (202) a sidelink transmission configuration for at least one service type or QoS requirement is independent of the DRX state of the first terminal device.
   31. An apparatus (600) implemented in a first terminal device, comprising:
one or more processors (601); and
one or more memories (602) comprising computer program codes (603),
the one or more memories (602) and the computer program codes (603) configured to, with the one or more processors (601), cause the apparatus (600) at least to:
determine (202) a sidelink transmission configuration for at least one service type or Quality of Service, QoS, requirement, wherein sidelink Discontinuous reception, DRX, is configured for the first terminal device and one or multiple second terminal devices;
determine (204) at least one transmission resource and/or at least one transmission time occasion for transmission of data associated with the service type or the QoS requirement based on the sidelink transmission configuration; and
transmit (206) the data associated with the service type or the QoS requirement to the one or multiple second terminal devices over the sidelink.
   32. The apparatus according to statement 31, wherein the one or more memories and the computer program codes are configured to, with the one or more processors, cause the apparatus to perform the method according to any one of statements 2-30.
   33. A method (400) implemented at a second terminal device, comprising:
receiving (402) data associated with at least one service type or Quality of Service, QoS, requirement from a first terminal device over the sidelink,
wherein at least one transmission resource and/or at least one transmission time occasion is determined for transmission of the data associated with the at least one service type or QoS requirement by the first terminal device based on a sidelink transmission configuration, and
wherein sidelink Discontinuous Reception, DRX, is configured for the first terminal device and second terminal device.
   34. The method according to statement 33, wherein the sidelink transmission configuration comprises at least one of:
a first sidelink transmission configuration that the first terminal device determines at least one transmission resource and/or at least one transmission time occasion without consideration of a DRX state of the second terminal device; or
a second sidelink transmission configuration that the first terminal device determines at least one transmission resource and/or at least one transmission time occasion with consideration of a DRX state of the second terminal device.
   35. The method according to statement 34, wherein the DRX state comprises active state or idle state.
   36. The method according to any of statements 33-35, further comprising: receiving an indication from the first terminal device or a network node, wherein the indication at least indicates the determined at least one transmission resource and/or at least one transmission time occasion.
   37. The method according to statement 36, wherein the indication indicates at least one of:
one or multiple resources in frequency;
one or multiple resources in time;
one or multiple transmission time occasions for initial transmission and/or one or multiple transmission time occasions for one or multiple retransmissions;
at least one Hybrid Automatic Repeat Request, HARQ, process identity, ID, for the at least one transmission time occasion;
at least one Redundancy version, RV, value for the at least one transmission occasion;
at least one New data indicator, NDI, of the HARQ process assigned for the at least one transmission time occasion; or
at least one of the service type, Logical channel ID, Logical channel group, LCG, or priority index for the data to be transmitted during the at least one transmission time occasion.
   38. The method according to statement 36 or 37, further comprising: transmitting a reply message to the first terminal device or a network node, wherein the reply message at least indicates whether the second terminal device will switch to active state from idle state to receive the data.
   39. The method according to any of statements 36-38, wherein the indication is received via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   40. The method according to any of statements 33-39, wherein the data and/or indication is received via at least one of dedicated sidelink transmission, groupcast sidelink transmission or broadcast sidelink transmission.
   41. The method according to any of statements 38-40, wherein the reply message is transmitted via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   42. The method according to any of statements 36-41, further comprising: switching to active state from idle state at the indicated at least one transmission resource and/or at least one transmission time occasion, or switching to active state from idle state according to the DRX configuration for the second terminal device.
   43. The method according to any of statements 36-42, wherein the indication is transmitted from the first terminal device or the network node in a first transmission time occasion according to the DRX state of the second terminal device.
   44. The method according to any of statements 36-43, wherein receiving the indication from the first terminal device or a network node further comprises: receiving the indication prior to receiving (402) the data associated with the service type or the QoS requirement.
   45. The method according to any of statements 36-44, wherein the indication is received from the first terminal device or a network node together with at least part of the data associated with the service type or the QoS requirement.
   46. The method according to any of statements 36-45, wherein receiving (402) data associated with at least one service type or QoS requirement from a first terminal device over the sidelink further comprises: receiving (402) data associated with the service type or the QoS requirement after a time period of receiving the indication.
   47. The method according to statement 46, wherein the time period is pre-configured.
   48. The method according to any of statements 33-47, wherein the first terminal device and the second terminal device have a same DRX configuration.
   49. The method according to any of statements 33-48, further comprising:
receiving a DRX configuration for the first terminal device from the first terminal device or a network node; and/or
transmitting a DRX configuration for second terminal device to the first terminal device or a network node.
   50. The method according to statement 49, wherein the DRX configuration is transmitted or received via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   51. The method according to any of statements 33-50, wherein at least one transmission resource during the at least one transmission time occasion when the second terminal device is in active state according to a DRX configuration for the second terminal device is determined.
   52. The method according to any of statements 33-51, wherein at least one transmission time occasion based on the DRX state of the second terminal device is determined, when the data and/or indication is to be received via dedicated sidelink transmission.
   53. The method according to any of statements 33-52, wherein
the first sidelink transmission configuration is determined for a delay sensitive service type or a service associated with a critical latency requirement; and/or
the second sidelink transmission configuration is determined for a delay insensitive service type or a service associated with a non-critical latency requirement.
   54. The method according to any of statements 33-53, further comprising: receiving a configuring message indicating the sidelink transmission configuration for the at least one service type or QoS requirement from a network node.
   55. The method according to statement 54, wherein the configuring message is received via at least one of:
a Radio Resource Control, RRC, signaling;
a Media Access Control, MAC, Control element, CE;
a Downlink Control Information, DCI; or
a System Information, SI.
   56. The method according to any of statements 34-55, further comprising: receiving a determination of the first sidelink transmission configuration or the second sidelink transmission configuration from the first terminal device or a network node.
   57. The method according to statement 56, wherein the determination is received via at least one of:
a Physical Sidelink Common Control Channel, PSCCH;
a Physical Sidelink Shared Channel, PSSCH;
a PC5-Radio Resource Control, RRC, signaling;
a PC5-Media Access Control, MAC, Control element, CE; or
a cellular connection.
   58. The method according to any of statements 33-57, wherein the determination of the sidelink transmission configuration for at least one service type or QoS requirement is independent of the DRX state of the first terminal device.
   59. An apparatus (600) implemented in a second terminal device, comprising:
one or more processors (601); and
one or more memories (602) comprising computer program codes (603),
the one or more memories (602) and the computer program codes (603) configured to, with the one or more processors (601), cause the apparatus (600) at least to:
receive (402) data associated with at least one service type or Quality of Service, QoS, requirement from a first terminal device over the sidelink;
wherein at least one transmission resource and/or at least one transmission time occasion is determined for transmission of the data associated with the at least one service type or QoS requirement by the first terminal device based on a sidelink transmission configuration, and
wherein sidelink Discontinuous Reception, DRX, is configured for the first terminal device and second terminal device.
   60. The apparatus according to statement 59, wherein the one or more memories and the computer program codes are configured to, with the one or more processors, cause the apparatus to perform the method according to any one of statements 34-58.
   61. A method (500) implemented at a network node, comprising:
transmitting (502) a configuring message indicating a sidelink transmission configuration for at least one service type or Quality of Service, QoS, requirement, to a first terminal device and/or one or multiple second terminal devices, or
transmitting (502′) the sidelink transmission configuration for at least one service type or QoS requirement to the one or multiple second terminal devices,
wherein sidelink Discontinuous Reception, DRX, is configured for the first terminal device and one or multiple second terminal devices.
   62. The method according to statement 61, wherein the sidelink transmission configuration comprises at least one of:
a first sidelink transmission configuration that the first terminal device determines at least one transmission resource and/or at least one transmission time occasion without consideration of a DRX state of the one or multiple second terminal devices; or
a second sidelink transmission configuration that the first terminal device determines at least one transmission resource and/or at least one transmission time occasion with consideration of a DRX state of the one or multiple second terminal devices.
   63. The method according to statement 61 or 62, further comprising: receiving an indication from the first terminal device and/or transmitting the indication to the one or multiple second terminal devices, wherein the indication at least indicates at least one transmission resource and/or at least one transmission time occasion.
   64. The method according to statement 63, wherein the indication indicates at least one of:
one or multiple resources in frequency;
one or multiple resources in time;
one or multiple transmission time occasions for initial transmission and/or one or multiple transmission time occasions for one or multiple retransmissions;
at least one Hybrid Automatic Repeat Request, HARQ, process identity, ID, for the at least one transmission time occasion;
at least one Redundancy version, RV, value for the at least one transmission occasion;
at least one New data indicator, NDI, of the HARQ process assigned for the at least one transmission time occasion; or
at least one of the service type, Logical channel ID, Logical channel group, LCG, or priority index for the data to be transmitted during the at least one transmission time occasion.
   65. The method according to statement 63 or 64, further comprising: receiving a reply message from the one or multiple second terminal devices, and/or transmitting the reply message to the first terminal devices, wherein the reply message at least indicates whether the one or multiple second terminal devices will switch to active state from idle state to receive data associated with the service type or the QoS requirement from the first terminal device over the sidelink.
   66. The method according to any of statements 63-65, wherein the indication is received and/or transmitted via a cellular connection, and/or the reply message is transmitted and/or received via a cellular connection.
   67. The method according to any of statements 61-66, further comprising at least one of:
receiving a DRX configuration for the first terminal device from the first terminal device;
transmitting a DRX configuration for the first terminal device to one or multiple second terminal devices;
receiving at least one DRX configuration for the one or multiple second terminal devices from the one or multiple second terminal devices; or
transmitting the at least one DRX configuration for the one or multiple second terminal devices to the first terminal device.
   68. The method according to any of statements 61-67, wherein the configuring message and/or the sidelink transmission configuration is transmitted via at least one of:
a Radio Resource Control, RRC, signaling;
a Media Access Control, MAC, Control element, CE;
a Downlink Control Information, DCI; or
a System Information, SI.
   69. The method according to any of statements 61-68, further comprising: determining the configuring message indicating sidelink transmission configuration for at least one service type or QoS requirement; or receiving the sidelink transmission configuration for at least one service type or QoS requirement from the first terminal device.
   70. The method according to any of statements 62-69, further comprising: receiving a determination of the first sidelink transmission configuration or the second sidelink transmission configuration from the first terminal device; and/or transmitting the determination of the first sidelink transmission configuration or the second sidelink transmission configuration to the one or multiple second terminal devices.
   71. An apparatus (600) implemented in a network node, comprising:
one or more processors (601); and
one or more memories (602) comprising computer program codes (603),
the one or more memories (602) and the computer program codes (603) configured to, with the one or more processors (601), cause the apparatus (600) at least to:
transmit (502) a configuring message indicating a sidelink transmission configuration for at least one service type or Quality of Service, QoS, requirement, to a first terminal device and/or one or multiple second terminal devices, or
transmit (502′) the sidelink transmission configuration for at least one service type or QoS requirement to the one or multiple second terminal devices,
wherein sidelink Discontinuous Reception, DRX, is configured for the first terminal device and one or multiple second terminal devices.
   72. The apparatus according to statement 71, wherein the one or more memories and the computer program codes are configured to, with the one or more processors, cause the apparatus to perform the method according to any one of statements 62-70.
   73. A computer-readable medium having computer program codes (603) embodied thereon for use with a computer, wherein the computer program codes (603) comprise codes for performing the method according to any one of statements 1-30.
   74. A computer-readable medium having computer program codes (603) embodied thereon for use with a computer, wherein the computer program codes (603) comprise codes for performing the method according to any one of statements 33-58.
   75. A computer-readable medium having computer program codes (603) embodied thereon for use with a computer, wherein the computer program codes (603) comprise codes for performing the method according to any one of statements 61-70.
   76. An apparatus (700A) implemented in a first terminal device, comprising:
a first determining module (701A) configured to determine (202) a sidelink transmission configuration for at least one service type or Quality of Service, QoS, requirement, wherein sidelink Discontinuous Reception, DRX, is configured for the first terminal device and one or multiple second terminal devices; and
a second determining module (702A) configured to determine (204) at least one transmission resource and/or at least one transmission time occasion for transmission of data associated with the at least one service type or the QoS requirement based on the sidelink transmission configuration; and
a transmitting module (703A) configured to transmit (206) the data associated with the service type or the QoS requirement to the one or multiple second terminal devices over the sidelink.
   77. An apparatus (700B) implemented in a second terminal device, comprising:
a receiving module (701B) configured to receiv (402) data associated with at least one service type or Quality of Service, QoS, requirement from a first terminal device over the sidelink;
wherein at least one transmission resource and/or at least one transmission time occasion is determined for transmission of the data associated with the at least one service type or QoS requirement by the first terminal device based on a sidelink transmission configuration, and
wherein sidelink Discontinuous Reception, DRX, is configured for the first terminal device and second terminal device.
   78. An apparatus (700C,700C′) implemented at a network node, comprising:
a first transmitting module (701C) configured to transmit (502) a configuring message indicating a sidelink transmission configuration for at least one service type or Quality of Service, QoS, requirement, to a first terminal device and/or one or multiple second terminal devices, or
a second transmitting module (701C′) configured to transmit (502′) the sidelink transmission configuration for at least one service type or QoS requirement to the one or multiple second terminal devices,
wherein sidelink Discontinuous Reception, DRX, is configured for the first terminal device and one or multiple second terminal devices.

1. A method implemented at a first terminal device, comprising:
determining a sidelink transmission configuration for at least one service type or Quality of Service, QoS, requirement, wherein sidelink Discontinuous Reception, DRX, is configured for the first terminal device and one or multiple second terminal devices;
determining, based on the determined sidelink transmission configuration, at least one transmission resource and/or at least one transmission time occasion for transmission of data associated with the at least one service type or the QoS requirement; and
transmitting the data associated with the service type or the QoS requirement to the one or multiple second terminal devices over the sidelink according to the determined at least one transmission resource and/or at least one transmission time occasion.

2. The method according to claim 1, wherein the determined sidelink transmission configuration comprises one of:
a first sidelink transmission configuration in which the first terminal device is to determine the at least one transmission resource and/or at least one transmission time occasion without consideration of a DRX state of the one or multiple second terminal devices; or
a second sidelink transmission configuration in which the first terminal device is to determine at least one transmission resource and/or at least one transmission time occasion with consideration of a DRX state of the one or multiple second terminal devices.

3. The method according to claim 1, wherein determining at least one transmission resource and/or at least one transmission time occasion further comprises:
determining the at least one transmission resource and/or at least one transmission time occasion without consideration of a DRX state of the one or multiple second terminal devices, when a first sidelink transmission configuration is determined for the service type or QoS requirement; or
determining the at least one transmission resource and/or at least one transmission time occasion with consideration of a DRX state of the one or multiple second terminal devices, when a second sidelink transmission configuration is determined for the service type or QoS requirement.

4. The method according to claim 2, wherein the DRX state comprises active state or idle state.

5. The method according to claim 1, further comprising: transmitting an indication to the one or multiple second terminal devices or a network node, wherein the indication at least indicates the determined at least one transmission resource and/or at least one transmission time occasion.

6. The method according to claim 5, wherein the indication indicates at least one of:
one or multiple resources in frequency;
one or multiple resources in time;
one or multiple transmission time occasions for initial transmissions and/or one or multiple transmission time occasions for one or multiple retransmissions;
at least one Hybrid Automatic Repeat Request, HARQ, process identity, ID, for the at least one transmission time occasion;
at least one Redundancy version, RV, value for the at least one transmission occasion;
at least one New data indicator, NDI, of the HARQ process assigned for the at least one transmission time occasion; or
at least one of the service type, Logical channel ID, Logical channel group, LCG, or priority index for the data to be transmitted during the at least one transmission time occasion.

7. (canceled)

8. The method according to claim 5, wherein the indication is transmitted via at least one of dedicated sidelink transmission, groupcast sidelink transmission or broadcast sidelink transmission.

9. The method according to claim 5, wherein transmitting the indication to the one or multiple second terminal devices or the network node further comprises: transmitting the indication in a first transmission time occasion according to the DRX state of the one or multiple second terminal devices.

10. The method according to claim 5, wherein transmitting the indication to the one or multiple second terminal devices or the network node further comprises: transmitting the indication prior to transmitting the data associated with the service type or the QoS requirement.

11. The method according to claim 5, wherein the indication is transmitted to the one or multiple second terminal devices together with at least part of the data associated with the service type or the QoS requirement.

12. The method according to claim 5, wherein transmitting the data associated with the service type or the QoS requirement to the one or multiple second terminal devices over the sidelink further comprises: transmitting the data associated with the service type or the QoS requirement after a time period of transmitting the indication.

13. (canceled)

14. The method according to claim 1, further comprising: receiving a reply message from the one or multiple second terminal devices or a network node, wherein the reply message at least indicates whether the one or multiple second terminal devices will switch to active state from idle state to receive the data.

15. (Canceled)

16. The method according to claim 1, wherein the first terminal device and the one or multiple second terminal devices have a same DRX configuration.

17. The method according to claim 1, further comprising:
transmitting a DRX configuration for the first terminal device to the one or multiple second terminal devices or a network node; and/or
receiving at least one DRX configuration for the one or multiple second terminal devices from the one or multiple second terminal devices or a network node.

18. (canceled)

19. The method according to claim 1, wherein determining at least one transmission resource and/or at least one transmission time occasion further comprises:
determining the at least one transmission resource during the at least one transmission time occasion when the one or multiple second terminal devices are in active state according to the DRX configuration for the one or multiple second terminal devices.

20. The method according to claim 1, wherein determining at least one transmission resource and/or at least one transmission time occasion further comprises:
determining the at least one transmission time occasion based on the DRX state of the second terminal device, when the data and/or indication is to be transmitted via dedicated sidelink transmission.

21-23. (canceled)

24. The method according to claim 1, wherein determining a sidelink transmission configuration for at least one service type or QoS requirement further comprises:
determining a first sidelink transmission configuration for a delay sensitive service type or a service associated with a critical latency requirement; and/or
determining a second sidelink transmission configuration for a delay insensitive service type or a service associated with a non-critical latency requirement.

25. The method according to claim 1, further comprising: receiving a configuring message indicating the sidelink transmission configuration for the at least one service type or QoS requirement from a network node.

26-32. (canceled)

33. A method implemented at a second terminal device, comprising:
receiving data associated with at least one service type or Quality of Service, QoS, requirement from a first terminal device over a sidelink,
wherein at least one transmission resource and/or at least one transmission time occasion used for the transmission of the data was determined by the first terminal device based on a sidelink transmission configuration, and wherein sidelink Discontinuous Reception, DRX, is configured for the first terminal device and the second terminal device.

34-60. (canceled)

61. A method implemented at a network node, comprising:
transmitting a configuring message indicating a sidelink transmission configuration for at least one service type or Quality of Service, QoS, requirement, to a first terminal device and/or one or multiple second terminal devices,
wherein sidelink Discontinuous Reception, DRX, is configured for the first terminal device and the one or multiple second terminal devices.

62-85. (canceled)
